(19) United States
(12) Patent Application Publication
(10) Pub. No.: US 2024/0289718 A1
(43) Pub. Date: Aug. 29, 2024

(54) SERVICE WORKFLOW INTEGRATION PLATFORM

(71) Applicant: Entrust Corporation, Shakopee, MN (US)

(72) Inventors: Justin Eayrs, St. Paul, MN (US); Andrew MacCuaig, Ottawa (CA); Priya Nagendran, Minneapolis, MN (US); Andrew DePompolo, St. Paul, MN (US); Arek Wojciechowski, Ottawa (CA); Dipak Tilekar, Plymouth, MN (US); Paul Henninger, Excelsior, MN (US); Noah Mank, Ottawa (CA); Dehong Pan, Ottawa (CA)

(21) Appl. No.: 18/590,591

(22) Filed: Feb. 28, 2024

Related U.S. Application Data
(60) Provisional application No. 63/487,497, filed on Feb. 28, 2023.
(60) Provisional application No. 63/512,386, filed on Jul. 7, 2023.
(60) Provisional application No. 63/593,826, filed on Oct. 27, 2023.

(51) Int. Cl. G06Q 10/0633

(52) U.S. Cl. CPC G06Q 10/0633

(57) ABSTRACT

A workflow integration platform is disclosed for use within a financial services context, or for issuance of cards (e.g., payment cards or identification cards). Data may be gathered and coordinated for each of a plurality of services, including user contact information, identity, identity document, and customer verification. Each of a plurality of such services may be executed in a coordinated manner. In some instances, a financial institution may use such coordinated workflows for new account creation, card issuance in a self-service context from a mobile application.

### CROSS-REFERENCE TO RELATED APPLICATIONS

The present application claims priority from U.S. Provisional Patent Application No. 63/487,497, filed on Feb. 28, 2023, U.S. Provisional Patent Application No. 63/512,386, filed on Jul. 7, 2023, and U.S. Provisional Patent Application No. 63/593,826, filed on Oct. 27, 2023. The disclosure of each of the previously-listed patent applications is hereby incorporated by reference in its entirety.

### BACKGROUND

Financial institutions, such as banks, often provide their customers with a variety of ways in which they may be able to interact with accounts held at that financial institution. Such methods may include access to, and management of, deposit accounts and/or accounts associated with payment cards.

Typically, a new customer, or a customer seeking to open a new account, is limited in terms of the manner in which they may be able to complete such an account opening transaction. This is because an account opening transaction may require additional assessments regarding the identity of the user for customer, verification of identity documents of that user or customer, validation of the customer if that customer is an existing customer of the financial institution, and the like. The services are typically not all implemented by or offered directly by the financial institution, and are largely not used in a self-service context by a financial institution account generation and opening. As such, improvements are desired which simplify overall workflows for financial services entities, in particular for workflows in which identity and identity document verification is required.

Additionally, many institutions, such as academic institutions and business enterprises, provide identification cards (ID cards) to individuals associated with the institutions. For example, universities may issue student ID cards. Typically, before issuing an ID card to an individual, the institution verifies the identity of the individual. The identity verification services are typically not all implemented by or offered directly by the card issuing institution, and are largely not used in a self-service context by card issuing institutions. As such, improvements are desired which simplify the overall workflows for card issuing institutions, in particular for workflows in which identity and identity document verification is required.

### SUMMARY

In general the present application is directed to a workflow integration platform that may be used, for example, within a ID card issuance context, or other context in which user contact information, identity, identity document, and customer verification processes are performed. Data may be gathered for each service and a coordinated workflow using each of a plurality of external services may be executed in a coordinated manner. In some instances, a card issuing institution may use such coordinated workflows for issuing digital and/or physical ID cards in a self-service context from a mobile application. In some cases, such processes may be coordinated with a mobile device that hosts a mobile application integrating a software development kit (SDK) configured for integration with a workflow integration platform. In a first aspect, a method of facilitating an identity-based self-service workflow via an integration platform is disclosed. The method includes obtaining, from a client device, a request to initiate a workflow at a workflow integration platform including a platform database. The method also includes, managing a workflow including two or more of a user contact information gathering service, an identity verification service, a device reputation service, an electronic signature service, or a completion service performing a process including: obtaining, at the workflow integration platform, user contact information; submitting the user contact information to a workflow service to register a user and receiving a user agent identifier; providing client device information and the user agent identifier to the device reputation service; receiving from the device reputation service a device trust score; providing the device trust store to the workflow service; in response to the workflow service determining to proceed based on the user information and the device trust score, receiving a client context at the workflow integration platform; associating the workflow with a correlation identifier at the workflow integration platform; receiving, at the workflow integration platform, a result of an assessment by the identity document verification service including at least an identity document verification score; providing a confirmation of completion of the identity document verification process to the workflow; and receiving, at the workflow integration platform, a final user assessment from the workflow, the final user assessment score corresponding to a completion of the workflow.

In a second aspect, a system includes a computing system comprising a processor and a memory storing instructions which, when executed, implement a workflow integration platform providing a payment and identity application. The workflow integration platform includes a platform database and being communicatively connected to a plurality of external services including at least an identity document verification service, an electronic signature service, and a device reputation service. The instructions that implement the workflow integration platform cause the computing system to perform: obtaining, from a client device, a request to initiate a workflow at a workflow integration platform including a platform database. The computing system is further configured to manage a workflow including two or more of a user contact information gathering service, an identity verification service, a device reputation service, an electronic signature service, or a completion service, the workflow being executable to: obtain, at the workflow integration platform, user contact information; submit the user contact information to a workflow service to register a user and receive a user agent identifier; provide client device information and the user agent identifier to the device reputation service; receive from the device reputation service a device trust score; provide the device trust store to the workflow service; in response to the workflow service determining to proceed based on the user information and the device trust score, receive a client context at the workflow integration platform; associate the workflow with a correlation identifier at the workflow integration platform; receive, at the workflow integration platform, a result of an assessment by the identity document verification service including at least an identity document verification score; provide a confirmation of completion of the identity document verification process to the workflow; and receive, at the workflow integration platform, a final user assessment from the workflow, the final user assessment score corresponding to a completion of the workflow.

In a third aspect, a system includes a workflow integration platform communicatively accessible via an application. The workflow integration platform being communicatively connected to a plurality of services including two or more of a user contact information gathering service, an identity verification service, a device reputation service, an electronic signature service, or a completion service. The system further includes an application element executable on a user device and communicatively connected to the workflow integration platform. The workflow integration platform is configurable to receive a definition of a workflow that includes a call to one or more of the plurality of services, the workflow being initiated in response to a request received from the application element executing on the user device. The call to the one or more of the plurality of services is instantiated from the workflow integration platform based on a definition of a workflow initiated in response to the request. A service from among the plurality of services completing execution communicates a service completion message and a service status to the workflow integration platform, thereby causing the workflow integration platform to call at least one other service of the plurality of services as defined in a workflow. The workflow includes, upon successful completion of the one or more services, communication of identity confirmation to a third party entity selected from among a financial account provider, a digital payment card issuer, or a physical card issuer.

In a further aspect, a method of issuing identification cards in a self-service context via an integration platform is provided. The method includes obtaining, from a client device, user contact information for a user; submitting the user contact information to an identity service to verify the user contact information; receiving, from the client device, a first image of the user and an image of an identification document of the user, the identification document including a second image of the user; submitting the image of the user and the image of the identification document to an identity document verification service; receiving, from the identity document verification service, a score corresponding to a similarity between the first image of the user and the second image of the user; in response to determining that the score is above a predetermined threshold, creating an enrollment for the user in an instant identity service; and transmitting to the client device, a digital identification card, the digital identification card issued by the instant identity service.

In a still further aspect, a system includes a computing system comprising a processor and a memory storing instructions which, when executed, implement a workflow integration platform providing issuance of digital and physical identification cards. The workflow integration platform includes a platform database and being communicatively connected to a plurality of external services including at least an identity service, an identity document verification service, and an instant identity service. The instructions that implement the workflow integration platform cause the computing system to: obtain, from a client device, user contact information; submit the user contact information to the identity service to verify the user contact information; receive, from the client device, a first image of the user and an image of an identification document of the user, the identification document including a second image of the user; submit the image of the user and the image of the identification document to an identity document verification service; receive, from the identity document verification service, a score corresponding to a similarity between the first image of the user and the second image of the user; in response to determining that the score is above a predetermined threshold, create an enrollment for the user in an instant identity service; and transmit to the client device, a digital identification card, the digital identification card issued by the instant identity service.

### BRIEF DESCRIPTION OF THE DRAWINGS

FIG. 1 illustrates an example environment in which aspects of the present disclosure may be implemented.

FIG. 2 is a block diagram of a system including a workflow integration platform implemented within a containerized environment, according to an aspect of the present disclosure.

FIG. 3 is a block diagram of an example computing system.

FIG. 4 illustrates an example account creation process at a financial institution that may require use of identity verification services, in accordance with the present disclosure.

FIG. 5 is a flow diagram of a portion of a workflow initiated by a user in association with a general workflow during which identity verification, identity document verification, and user contact verification are performed, according to an example embodiment.

FIG. 6 is a flow diagram of a portion of a workflow implemented using a workflow integration platform, the workflow including a user contact information collection and verification process, according to an example embodiment.

FIG. 7 is a flow diagram of a portion of the workflow of FIG. 5 including an identity verification process, according to an example embodiment.

FIG. 8 is a flow diagram of a portion of a workflow of FIG. 5 including a customer verification process and a completion process, according to an example embodiment.

FIG. 9 is a flow diagram of a portion of a workflow including issuance of a digital card to a user from a financial institution, according to an example embodiment.

FIG. 10 is a flow diagram of a portion of a workflow implementing a simplified financial institution initiation process including user acceptance of terms and conditions, according to an example embodiment.

FIG. 11 is a flow diagram of a portion of a workflow implementing account creation and wallet provisioning processes within the simplified financial institution initiation process, according to an example embodiment.

FIG. 12 is a flow diagram of a portion of a workflow including issuance of a digital card to a user from a financial institution, within the simplified financial institution initiation process, according to an example embodiment.

FIG. 13 is a flow diagram of a portion of a workflow prompting user acceptance of terms and conditions of a particular entity, according to an example embodiment.

FIG. 14 is a flow diagram of a portion of a workflow including creation of the account at a financial institution, according to an example embodiment.

FIG. 15 is a flow diagram of a portion of a workflow including provisioning a digital wallet for a customer of a financial institution, according to an example embodiment.

FIG. 16 is a schematic depiction of a graphical user interface displayed on a mobile device as part of a digital card issuance process, in accordance with an example embodiment.

FIG. 17 is a schematic depiction of a graphical user interface displayed on a mobile device in response to selection of a manual entry option in the user interface of FIG. 16, according to an example embodiment.

FIG. 18 is a schematic depiction of a graphical user interface displayed on a mobile device for capture of communication preference information as part of a manual entry option, according to an example embodiment.

FIG. 19 is a schematic depiction of a graphical user interface for capture of contact information as part of a manual entry option, according to an example embodiment.

FIG. 20 is a schematic depiction of a graphical user interface for automatic capture of user information from an identification card, according to an example embodiment.

FIG. 21 is a schematic depiction of a graphical user interface for self-portrait capture according to an example embodiment.

FIG. 22 is a schematic depiction of a graphical user interface for confirmation of a captured self-portrait according to an example embodiment.

FIG. 23 is a schematic depiction of a graphical user interface displaying the user information captured from an identification card for confirmation in accordance with an example embodiment.

FIG. 24 is a schematic depiction of a graphical user interface displaying the user information captured from an identification card for confirmation in accordance with an example embodiment.

FIG. 25 is a schematic depiction of a graphical user interface useable to capture a social security number of a card applicant in accordance with an example embodiment.

FIG. 26 is a schematic depiction of a terms and conditions user interface, in accordance with an example embodiment.

FIG. 27 is a schematic depiction of a graphical user interface useable to set a PIN code for a digital payment card in accordance with an example embodiment.

FIG. 28 is a flowchart of an example method of use of the one or more user interfaces presented in accordance with the workflow integration platform as part of a card issuance process.

FIG. 29 is a flowchart of an example method of registering a user and issuing a digital ID card.

FIG. 30 is a flowchart of an example method of issuing a physical ID card.

FIG. 31 is a schematic depiction of a graphical user interface for initiating registration and issuance of a physical ID card.

FIG. 32 is a schematic depiction of a graphical user interface for inputting user contact information for verification.

FIG. 33 is a schematic depiction of a graphical user interface for verifying user contact information.

FIG. 34 is a schematic depiction of a graphical user interface presented during manual authentication of user identity.

FIG. 35 is a schematic depiction of a graphical user interface presented upon successful registration of a user.

FIG. 36 is a schematic depiction of a graphical user interface for initiating creation of a passkey.

FIG. 37 is a schematic depiction of a graphical user interface for creating a passkey.

FIG. 38 is a schematic depiction of a graphical user interface for initiating issuance of a digital ID card.

FIG. 39 is a schematic depiction of a graphical user interface presenting a digital ID card stored in a digital wallet.

FIG. 40 is a schematic depiction of a graphical user interface for authenticating a user to initiate issuance of a physical ID card.

FIG. 41 is a schematic depiction of a graphical user interface for using a passkey to authenticate a user.

FIG. 42 is a schematic depiction of a graphical user interface for initiating capture of a QR code for printer identification.

FIG. 43 is a schematic depiction of a graphical user interface for capturing a QR code.

FIG. 44 is a schematic depiction of a graphical user interface for verifying printer information.

FIG. 45 is a schematic depiction of a graphical user interface presenting confirmation that a physical ID card is printing.

### DETAILED DESCRIPTION

As briefly described above, in general the present application is directed to a workflow integration platform that may be used, for example, to verify users' identities and issue digital and/or physical ID cards, financial cards (e.g., credit cards, debit cards, and the like), to verified users. In an example, the workflow integration platform may be used within a financial services context, or other context in which user contact information, identity, identity document, and customer verification processes are performed. Data may be gathered for each service and a coordinated workflow using each of a plurality of external services may be executed in a coordinated manner. In some instances, a financial institution may use such coordinated workflows for new account creation in a self-service context from a mobile application. In other examples, the workflow integration platform may be used in any context in which ID cards are issued to users, including within academic institutions with student ID cards and companies with employee ID badges.

In some cases, such processes may be coordinated with a mobile device that hosts a mobile application integrating a software development kit (SDK) configured for integration with a workflow integration platform.

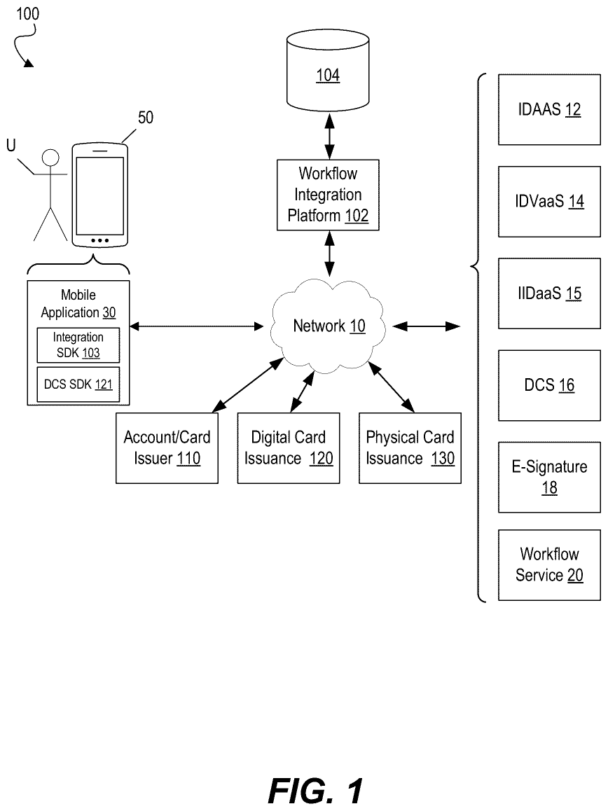

FIG. 1 illustrates an example environment 100 in which aspects of the present disclosure may be implemented. The environment 100 includes a workflow integration platform 102 that is communicatively connected to an account/card issuer 110 and a digital card issuing system 120 via a network 10. In an example, the account/card issuer 110 is a financial institution. In alternative examples, the account/card issuer 110 is any issuer of accounts or cards-both digital and physical-including academic institutions and companies.

In the example shown, a plurality of services are available via network 10 to be called as part of various services that may be performed by an account/card issuer 110. The services may include identity as a service (IDaaS) 12, identification verification as a service (IDVaaS) 14, instant identity as a service (IIDaaS) 15, digital card services (DCS) 16, electronic signature services 18, and workflow services 20. In typical arrangements, a account/card issuer 110 may call one or more of the services as part of the workflows of the account/card issuer 110, for example for account creation and/or card issuance. Such services may be referred to also as identity services generally, as they assist with various aspects of verification of a user's identity, identity information, or the like.

In the example shown, the environment 100 includes a user U having a mobile device 50 with a mobile application 30 installed thereon. In this example, the mobile application includes an integration SDK 103 and a digital card services SDK 121. The bubble application will be issued to the user by the account/card issuer 110, and the SDKs 103, 121 may assist in providing services to the user via their mobile device.

As described in further detail below, the workflow integration platform 102 is communicatively connected to a workflow database 104. The workflow database 104 is used to store data gathered as part of a workflow, which may be used through various other parts of the workflow to perform various self-service workflow tasks for the user with respect to the account/card issuer 110. That is, the workflow integration platform 102 may, in coordination with the integration SDK 103, interact with the workflow service 20 to call various other services, such as services 12-18, thereby accomplishing various account opening and card issuance processes. In some instances, in particular for digital card issuance, the workflow integration platform 102 may provide data to the digital card issuance system 120, which may cooperate with digital card system SDK 121 of the mobile application 34 providing a digital card to the user. In some examples, a physical card issuance system 130 may also initiate issuance of a physical card. For example, in one embodiment, the physical card issuance system 130 may include a printer connected to the network 10 that prints physical ID cards. In another embodiment, the physical card issuance system 130 may include a card issuance device, such as a card printer, useable to program physical smart cards having an integrated circuit (IC) chip embedded thereon. In such instances, the physical card issuance system 130 may print or emboss indicia onto a physical smart card having such an IC chip embedded thereon, and may also program the IC chip appropriately, in accordance with an operating system format and including personalization data and encryption keys necessary to effectuate payment using a payment network (e.g., VISA/MC, American Express, and the like). In an embodiment, the digital card issuance system 120 and the physical card issuance system 130 are the same system, operating as an instant physical and/or digital card issuance platform available as a cloud-based offering by a financial institution or other account/card issuer.

Examples of workflows and processes performed by the account/card issuer 110, mobile application 30, digital card issuing system 120, and physical card issuance system 130 are provided below. The examples described herein include account and digital card issuance by a financial institution as well as digital and physical card issuance by an academic institution; however, the systems and methods described herein are not limited to these examples and are applicable to other embodiments in which accounts and/or cards are issued.

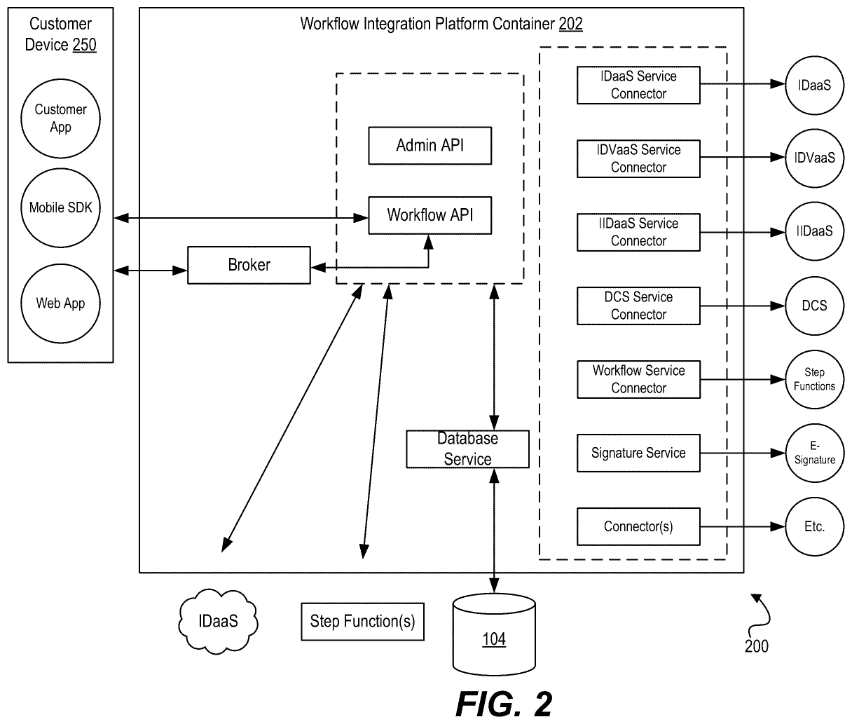

FIG. 2 is a block diagram of a system 200 including a workflow integration platform 202, according to an aspect of the present disclosure.

Generally speaking, the workflow integration platform 202 may be implemented within a containerized environment, such as a cloud environment, and may be configured for interaction with a plurality of third-party services, including IDaaS, IDVaaS, DCS, E-signature, and various defined step functions included in workflows. The workflow integration platform 202 may be located on a server, such as a payment and identity server system, which hosts other identity services as well. Such services may correspond to the services 12-18 described above in conjunction with FIG. 1. Additionally, the workflow integration platform 202 may represent one example of the workflow integration platform 102 of FIG. 1.

In the example shown, the workflow integration platform 202 is communicatively connected to a customer device 250, which may correspond to the mobile device 50 of FIG. 1, or may be any of a variety of other types of devices. Accordingly, the customer device 250 may correspond to a customer application including one or more mobile SDKs, a web application, or the like.

In the example shown, the workflow integration platform 202 includes a workflow coordinator that includes an administrative API and a workflow API. The workflow API may be accessible via the customer device 250, and may publish events via a broker to the customer device. In particular, rather than pushing messages directly to the customer device 250, the workflow API may cause the broker to send notifications that an update is available, allowing a customer device to retrieve updated information as part of a next workflow step. In this way, the workflow API does not interfere with other operations of the customer device, and requires only that the customer device access or provide data to the workflow API when convenient.

In the example shown, the workflow coordinator is communicatively connected to a database service which manages storage of data obtained at the workflow coordinator at workflow database 104. The workflow coordinator is further connected to one or more step functions maintained external to the workflow integration platform 202, as well as a cloud-based identity as a service (IDaaS) system.

In the example shown, a connector subsystem includes a plurality of service connectors which allow the workflow coordinator to call the respective services described previously. Each service may have its own REST API to which requests may be submitted and responses received.

Generally speaking, the workflow integration platform 202 may be implemented using a micro services architecture, such that a separate micro service is used for communication/integration with each external service to be integrated. The external services may be implemented within the same overall entity or server subsystem (e.g., a payment and identity server, as described herein), or may be implemented as third-party services. Each micro service encapsulates logic for integration with APIs exposed by the external services. This allows for extensibility and scalability of the workflow integration platform 202 as specific services required as part of workflows change over time, or as workflows themselves change over time.

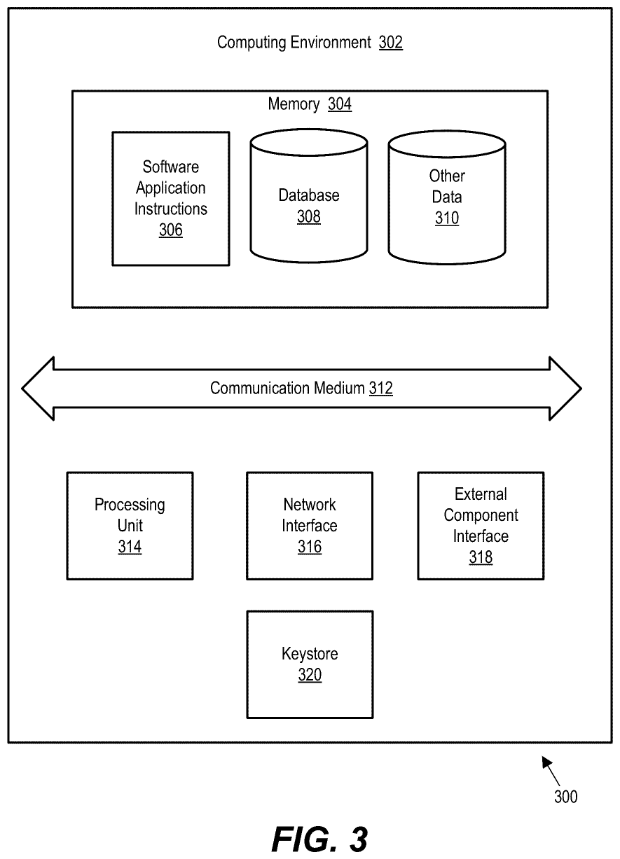

FIG. 3 illustrates an example system 300 with which disclosed systems and methods can be used. In an example, the following can be implemented in one or more systems 300 or in one or more systems having one or more components of system 300: the workflow integration platforms 102, 202, mobile device 50, 250, various services 12-20, and computing systems associated with the account/card issuer 110, digital card issuance system 120, and/or physical card issuance system 130.

In an example, the system 300 can include a computing environment 302. The computing environment 302 can be a physical computing environment, a virtualized computing environment, or a combination thereof. The computing environment 302 can include memory 304, a communication medium 312, one or more processing units 314, a network interface 316, an external component interface 318, and a keystore 320.

The memory 304 can include a computer readable storage medium. The computer storage medium can be a device or article of manufacture that stores data and/or computer-executable instructions. The memory 304 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

The memory 304 can store various types of data and software. For example, as illustrated, the memory 304 includes software application instructions 306, one or more databases 308, as well as other data 310. The communication medium 312 can facilitate communication among the components of the computing environment 302. In an example, the communication medium 312 can facilitate communication among the memory 304, the one or more processing units 314, the network interface 316, the external component interface 318, and the keystore 320. The communications medium 312 can be implemented in a variety of ways, including but not limited to a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communications medium.

The one or more processing units 314 can include physical or virtual units that selectively execute software instructions, such as the software application instructions 306. In an example, the one or more processing units 314 can be physical products comprising one or more integrated circuits. The one or more processing units 314 can be implemented as one or more processing cores. In another example, one or more processing units 314 are implemented as one or more separate microprocessors. In yet another example embodiment, the one or more processing units 314 can include an application-specific integrated circuit (ASIC) that provides specific functionality. In yet another example, the one or more processing units 314 provide specific functionality by using an ASIC and by executing computer-executable instructions.

The network interface 316 enables the computing environment 302 to send and receive data from a communication network. The network interface 316 can be implemented as an Ethernet interface, a token-ring network interface, a fiber optic network interface, a wireless network interface (e.g., Wi-Fi), a Bluetooth interface, or another type of network interface.

The external component interface 318 enables the computing environment 302 to communicate with external devices. For example, the external component interface 318 can be a USB interface, Thunderbolt interface, a Lightning interface, a serial port interface, a parallel port interface, a PS/2 interface, or another type of interface that enables the computing environment 302 to communicate with external devices. In various embodiments, the external component interface 318 enables the computing environment 302 to communicate with various external components, such as external storage devices, input devices, speakers, modems, media player docks, other computing devices, scanners, digital cameras, and fingerprint readers.

The keystore 320 enables the computing environment 302 to securely maintain cryptographic artifacts, including certificates and private keys, that are used for cryptographic protocols to authenticate users. In an example, the keystore 320 is a hardware-backed keystore. In alternative examples, the keystore 320 can be any type of keystore capable of storing cryptographic artifacts.

Although illustrated as being components of a single computing environment 302, the components of the computing environment 302 can be spread across multiple computing environments 302. For example, one or more of instructions or data stored on the memory 304 may be stored partially or entirely in a separate computing environment 302 that is accessed over a network. Depending on the size and scale of the computing environment 302, it may be advantageous to include one or more load balancers to balance traffic across multiple physical or virtual machine nodes. Each node may be configured to be capable of running the full system 300, such that portal can run and schedule jobs and serve the portal user interface as long as a single node remains functional. The environment 302 may include monitoring technology to determine when a node is not functioning so an appropriate action can be taken.

### I. FINANCIAL INSTITUTION VERIFICATION AND ACCOUNT ISSUANCE

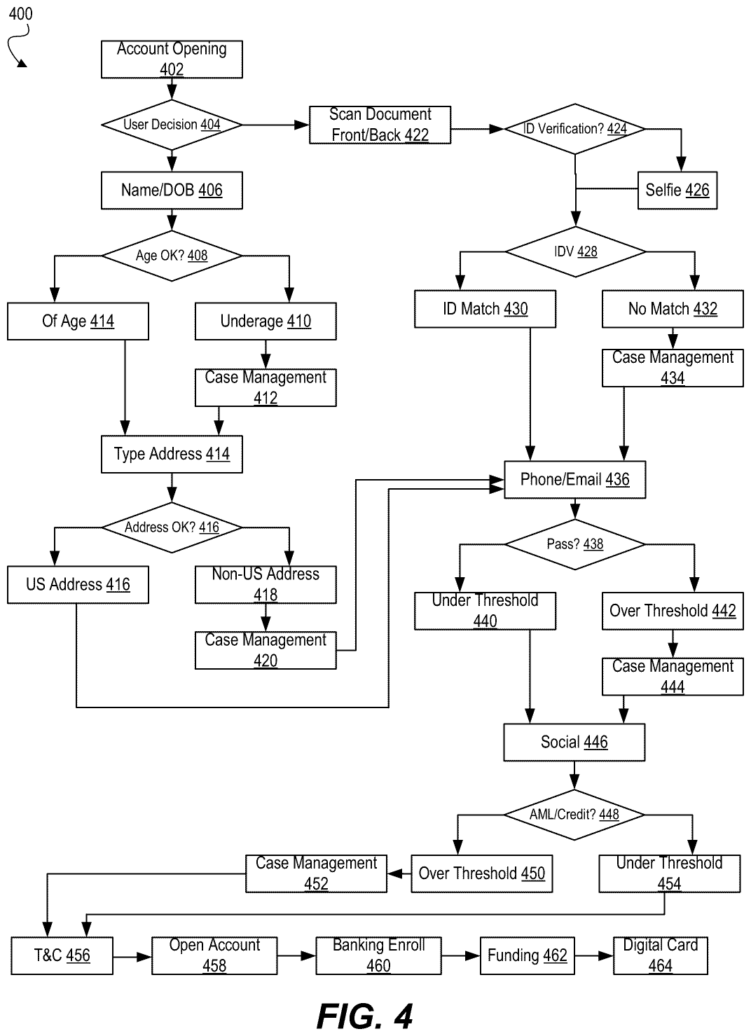

Turning to FIGS. 4-28, examples of the workflow integration platform in the context of a financial institution are described. FIG. 4 illustrates an example account creation process 400 at a financial institution that may require use of identity verification services, in accordance with the present disclosure. The account creation process 400 represents a mere example of one type of process flow, and is not intended as limiting on any other processes described herein.

Generally speaking, the account creation process 400 may be initiated by an account opening request at operation 402. A user may make a decision, at operation 404, whether to provide an identification document or not. If the user does not provide an identification document, that user may be prompted, at operation 406, to provide a name and date of birth. Based on the date of birth, the institution may determine whether that potential customer is of age (at operation 408) or underage (at operation 410). If underage, a case management process 412 may be initiated to determine if the user is nevertheless authorized to proceed. The user may also be prompted, at operation 414, to type an address, which may be determined whether it corresponds to a US address (at operation 416) or a non-US address (at operation 418). Similarly to the underage scenario, for non-US addresses, a case management process, at operation 420, may be performed to determine whether to proceed with the account opening.

If the user does provide an identification document, the user may be prompted, at operation 422, to scan a front and back of the document, and an ID verification prompt at operation 424 allows the user to further take a selfie photograph at operation 426. An identity verification process, at operation 428, determines whether the identification document matches a known identity to an identity verification service (at operation 430). If no match exists as determined at operation 432, a case management process, at operation 434, may be initiated to determine whether to allow the account opening to proceed.

In general, the identity verification process may be used to compare the captured selfie photograph with an image on the identification document (e.g., on a driver's license or passport) to determine a match between those images, indicating that the user is the same individual depicted on the identification document. The match may be performed using one or more image analysis and matching techniques, use of biometric feature matching between the images, or use of deep learning models, such as convolutional neural networks, and the like, trained on matched and non-matched pairs of identification images, to determine the presence of a match.

In some embodiments, the identity verification process may further apply a liveness determination in which the selfie photograph is analyzed to determine if the image is of a live person, or if it may be an image of a facsimile or non-live reproduced image of the person. Such image analysis may be based on a variety of criteria, such as image metadata, or information included in the image itself, such as requiring the image to be a video and requiring user movement, or detecting liveness in a still image using various indicators of potential non-liveness (e.g., detecting edges of a document, detecting image artifacts indicative of a digital image, and the like).

Once either user contact information or a user identification document is provided, the user may be prompted to provide a phone and/or email address at operation 436. That address or contact information may be compared to existing available information at operation 438, and may be matched against such existing information to determine a difference between the received and available contact information. If the difference is below a threshold, the operation may proceed, at operation 440. If the difference is above a threshold, at operation 442, further case management may be required at operation 444. A Social Security number may be prompted as well at operation 446, and a credit check may be performed at operation 448. If risk is above a predetermined threshold at operation 450, further case management may be required at operation 452; otherwise if the risk is below a predetermined threshold at operation 454, account management may be allowed to proceed.

At this point, the user may be prompted to accept terms and conditions of the institution at operation 456. The user may be allowed to open an account at operation 458, enroll in various online banking services at operation 460, fund the account at operation 462, and issue a digital and/or physical card at operation 464.

Referring to FIG. 4, although exemplary, it can be seen that in process 400, each of the steps of this overall method may be performed by the user after downloading a mobile application, for example the mobile application 30 of FIG. 1. Furthermore, in this process flow, identity verification and user details are validated prior to allowing the user to proceed with creation of accounts at a financial institution in a circumstance where the user is not physically present at that financial institution.

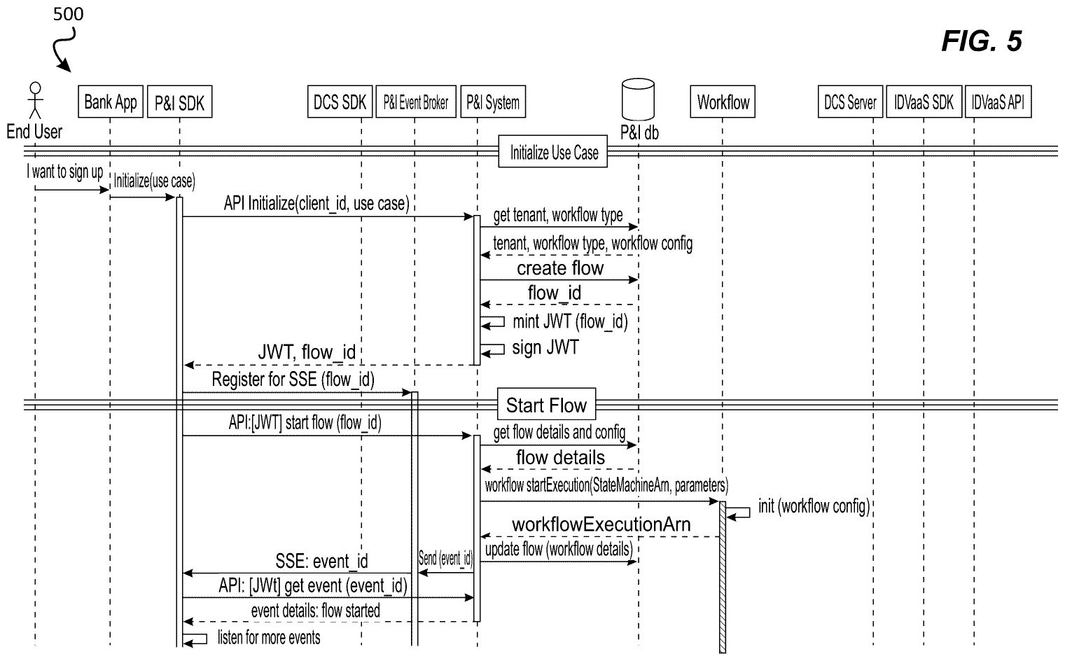

Referring now to FIGS. 5-15, various flow diagrams illustrating operation of a workflow integration platform, such as seen in FIG. 2, above, are provided in the context of the various payment account initiation processes of FIG. 4, as well as other process types requiring identity verification from a plurality of external services. Generally speaking, the flow diagrams illustrate operations among entities as described above, including a financial institution 110, card issuance system 120, workflow integration platform 102, 202, various services, including a workflow service 20, and an application and associated SDK of an application, such as a financial institution's mobile application.

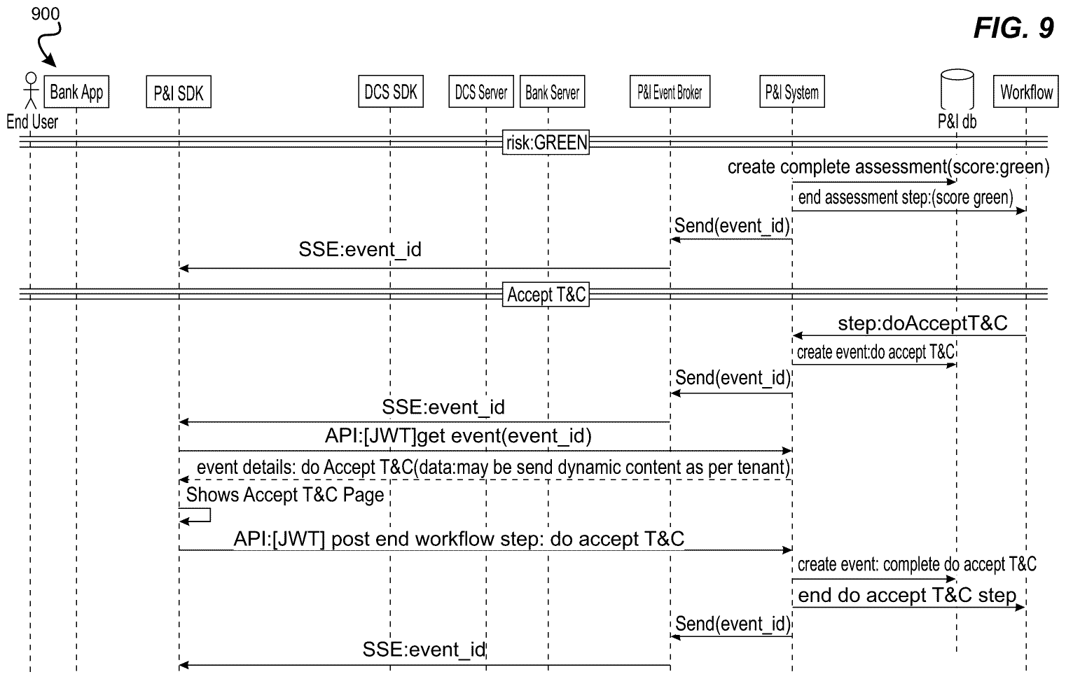

For purposes of the present disclosure, the workflows are generally described in groups; FIGS. 5-8 illustrate a general process for user validation, and FIGS. 9-12 and 13-15 illustrate examples of account creation and card issuance within such a common workflow. The definitions of the flows, in sequence diagram source code, are provided below in Appendices A-C, respectively.

Referring first to FIGS. 5-8, a first set of flow diagrams illustrate a general process for user validation at a financial institution, according to an example embodiment. The user account creation process may correspond to the portions of user account creation that occur once identity verification has occurred in FIG. 4, for example.

As depicted in FIG. 5, a first flow diagram 500 illustrates a portion of a workflow prompting user acceptance of terms and conditions of a particular entity, according to an example embodiment. In this example, the flow diagram is initiated in response to a user and indication a mobile application, such as a bank application that they wish to sign up for a banking service. The mobile application may be, for example, the mobile application 30 of FIG. 1. In this example, the mobile application will call an SDK (e.g. integration SDK 103), which may transmit an initialization message to the workflow integration platform, which may be implemented on a payment and identity system as described above. The payment and identity system will submit a request for a tenant and workflow type to a workflow database 104, and will receive response the tenant ID, paperwork flow type, and a peripheral configuration which are stored in the workflow database. The payment and identity system, specifically the workflow integration platform, will transmit a create flow request to the workflow database 104, which will generate a workflow and return a workflow ID. The payment and identity system, via the workflow integration platform, will sign the workflow identifier and send the workflow identifier back to the integration SDK 103. The integration SDK may transmit a request to register for event updates with an event broker, such as the broker seen in FIG. 2. The event broker will provide updates regarding the workflow back to the integration SDK 103 during execution of the workflow.

The integration SDK 103 may transmit a request to the workflow integration platform to start the workflow using the workflow ID. The workflow integration platform will obtain workflow details and configuration from the workflow database, and initiate execution workflow using a workflow service (e.g., workflow service 20 of FIG. 1, or the step functions as seen in FIG. 2). The workflow service will return details regarding workflow execution to the workflow integration platform, which updates the workflow details in the workflow database and transmits an update back to the integration SDK via a message sent to the broker for the integration SDK to retrieve updated event details. Accordingly, the integration SDK will obtain information indicating that the workflow has been initiated.

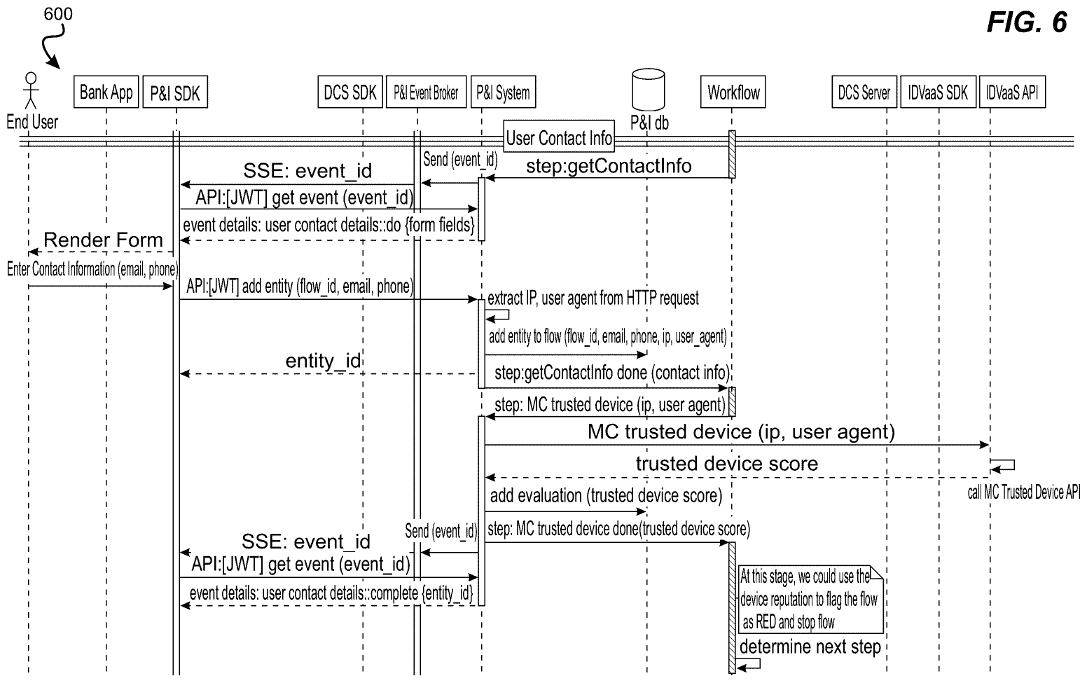

FIG. 6 is a flow diagram 600 of a continuing portion of a workflow implemented using a workflow integration platform. In this instance, the flow diagram 600 depicts a continuation of the workflow seen in FIG. 5, and illustrates a user contact information collection and verification process, according to an example embodiment.

In this example, the workflow service will transmit a request to the workflow integration platform to obtain contact information of the user. The workflow integration platform will transmit an update to the broker, which notifies the integration SDK 103 of an update event; when the integration SDK obtains the event, the workflow integration platform provides a request for specific event details and user contact details in the form of a plurality of form fields. The integration SDK will render a form and obtain contact information from the user U, including an email address and a phone number.

Once the integration SDK receives the contact information, it will return to the workflow integration platform the workflow ID, email address, and phone number. The workflow integration platform will store that information in the workflow database and will return contact information to the workflow service. The workflow service will then transmit a request to the workflow integration platform to determine whether the requesting device (e.g. mobile device 50, 250) is a trusted device. The workflow integration platform will transmit an IP address of the device as well as a user agent identifier to an identity verification as a service (IDVaaS) API, which will return a trusted device score. The workflow integration platform will store the trusted device score in the workflow database, and return the trusted device score to the workflow service. The workflow integration platform will also send an update back to the integration SDK via a further broker event, allowing the SDK to retrieve updated event details using an event identifier associated with the workflow. Specifically, the workflow integration platform will indicate to the integration SDK that the user contact details acquisition is now complete.

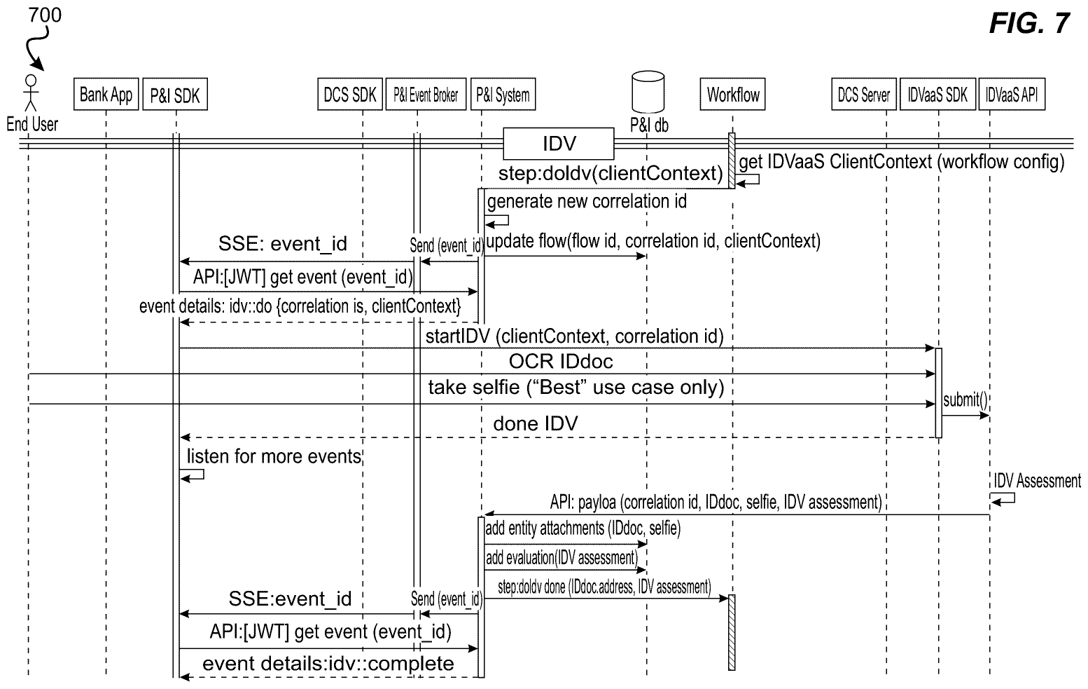

At this stage, depending on the trusted device score, the workflow service may elect to continue, or may elect to halt the workflow depending on trustworthiness of the device. Presuming that the device is trustworthy, the flow may continue in accordance with a flow diagram 700 as depicted in FIG. 7. In this example flow, and identity verification process is performed. Specifically, the workflow service available obtain a client context via an identity verification service, by transmitting a client context to the workflow integration platform. The workflow integration platform will generate a correlation identifier and store the correlation identifier and client context information alongside the flow identifier for the overall workflow in the workflow database. The workflow integration platform will also send to the integration SDK 103 the correlation identifier and client context via a broker message and request/update arrangement.

The integration SDK 103 will then transmit a message to an identity verification as a service SDK (IDVaaS SDK, which may be another SDK integrated into a mobile application, or may be part of the IDVaaS services provided as described above). Additionally, the user U will be prompted to provide a digital copy of an identification document. This may include, for example, an image of each of the front and back of an identification document, preferably after having any identifying information extracted via optical character recognition (OCR). The user U may also be prompted to provide a self portrait image (a “selfie”) for use and verification. All of this information may be submitted to the IDVaaS API, which will perform an identity verification assessment and return to the workflow integration platform a copy of the identity document, the selfie, and results of the identity verification assessment. In an example, the identity verification assessment includes comparing the selfie to an image of the user U on the identity document to determine if the images match. The workflow integration platform will store the copy of the identity document and selfie in the workflow database, as well as the identity verification assessment. This data will also be provided back to the workflow service, and an update is sent back to the integration SDK 103, again via a broker message and request/update arrangement.

In an alternative embodiment, rather than return the copy of the identity document, the selfie, and the results of the identity verification assessment to the workflow integration platform, the IDVaaS may instead transmit the copy of the identity document, the selfie, and the results of the identity verification assessment back to the user U, e.g., to a mobile device of the user without first routing such information via the workflow integration platform. In examples, the IDVaaS may send only the results of the identity verification assessment to the user U, as the user U may already have a copy of the identity document and the selfie from when the user U captured the copy of the identity document and the selfie. The user U may then submit the copy of the identity document, the selfie, and the results of the identity verification assessment to the workflow integration platform.

Further, in some embodiments, additional or alternative methods may be used to perform identity verification of the user U. For example, the user U may submit multiple selfies or a video of the user U from different angle. Additionally or alternatively, the selfies may be captured at different distances, or the user U may make different facial expressions in the selfies. In this example, the identity verification assessment includes ensuring the user U is a live person rather than a spoof—i.e., a photo of the user U, a screen, a mask of the user U, or a deepfake.

In another example, the identity verification assessment includes verifying that the identity document is authentic. In an embodiment, characters captured in the copy of the identity document are analyzed to determine if the characters are in a predefined font that is expected with a type of identity document. The type of identity document may be input by the user U, or the type of identity document may be determined by analyzing the copy of the identity document, such as by using textual and non-textual classification processes. In some embodiments, the identity document is authenticated by capturing multiple images of the identity document using different image capture settings (e.g., shutter speed, flash intensity, aperture, or gain). The multiple images are partitioned into subsets based on an alignment of the identity document in the images and the settings used to capture the images, and the subsets of images are processed to identity a region of interest. An authentication score is generated based on the region of interest, and the identity document is authenticated based on the authentication score.

In another example, the digital copy of the identity document is obtained by reading an integrated circuit embedded into the identity document. For example, if the identity document is a biometric passport, the digital copy of the identity document may be obtained by reading an embedded electronic microprocessor chip embedded within the biometric passport.

In a further example, the digital copy of the identity document includes a secure transaction object as described in U.S. Provisional Patent Application No. 63/549,270, filed on Feb. 2, 2024, and entitled “Distributable Secure Transaction Object”, the disclosure of which is hereby incorporated by reference in its entirety. In an embodiment, the secure transaction object includes information from an identity document and can be used to authenticate the user U during the identity verification assessment. For example, the secure transaction object may include an image of the user U that can be compared to the selfie to authenticate the user U.

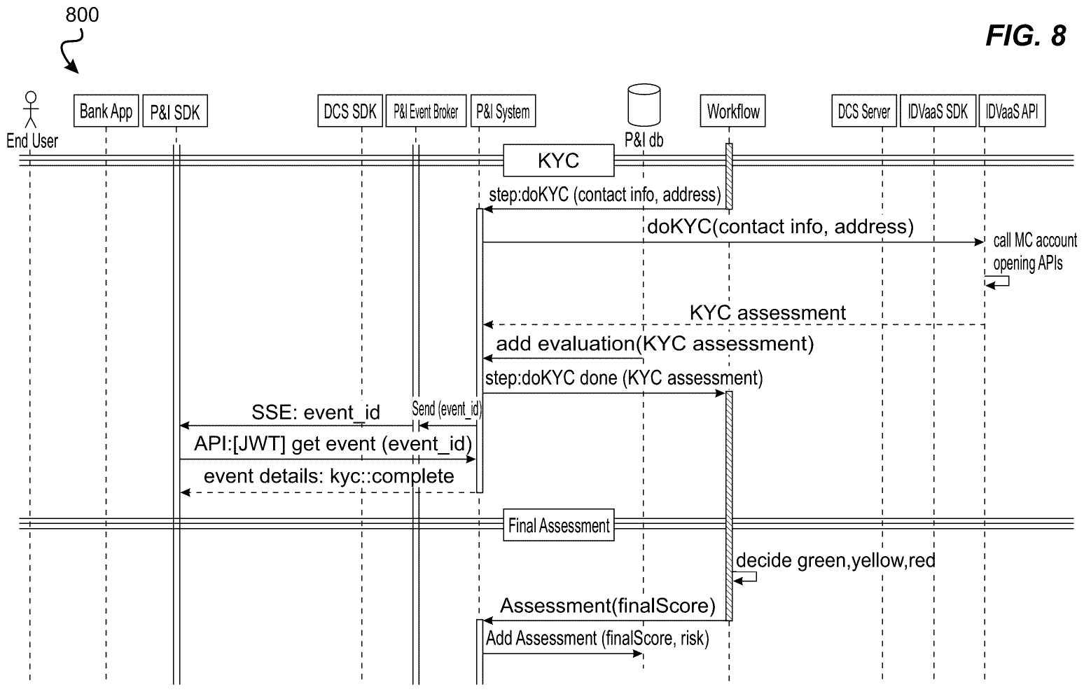

In FIG. 8, a workflow 800 illustrates a continuation of the flow of FIGS. 5-7, and illustrates a further process performed at the identity verification service, referred to as a know your customer (KYC) service. Such a service is used to reduce financial fraud during account opening or other financial transactions. In this instance, the workflow service transmits a know your customer requests including contact information and address information of the user, to the workflow integration platform. The workflow integration platform will submit the request to the identity verification as a service API (IDVaaS API), which returns an assessment (e.g., a fraud likelihood score). This evaluation may be stored in the workflow database, and results of the assessment may be returned to the workflow service. Additionally, an update will be provided back to the integration SDK 103 indicating that the KYC process is complete, again via a broker message and request/update arrangement.

Continuing the workflow 800, the workflow service will determine an overall score for the user, for example on a green/yellow/red assessment basis. That final score may be returned to the workflow integration platform, which stores the assessment in the workflow database, and may transmit that response (not shown) back to the integration SDK indicating success (or at least completion) of the process, again via a broker message and request/update arrangement.

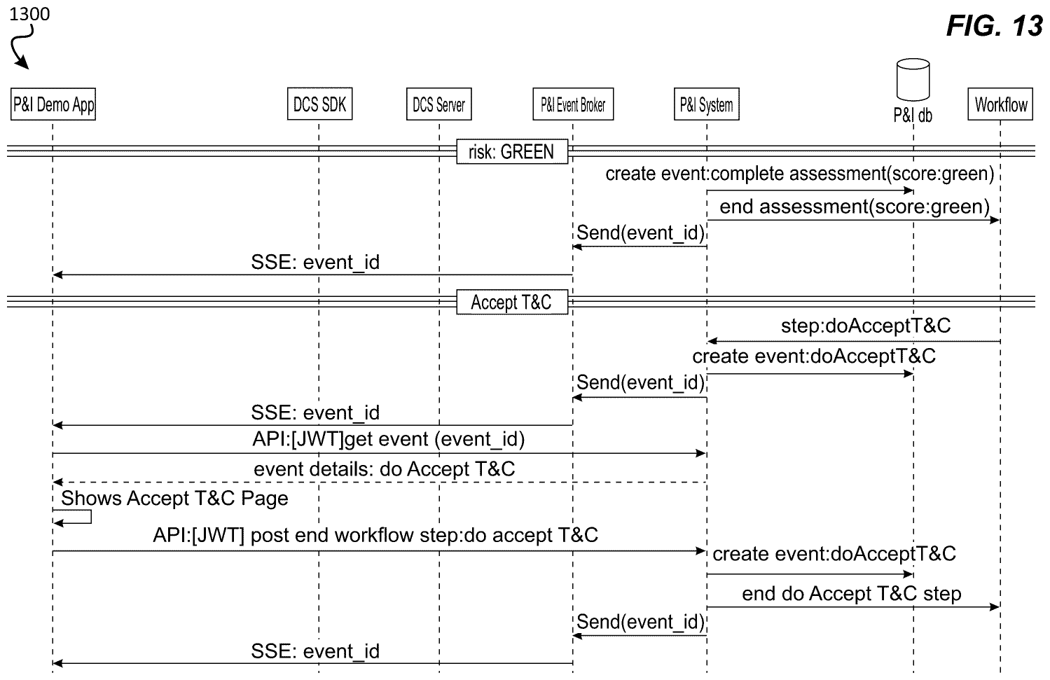

At this stage, user verification is now complete, and the user may be able to perform one or more transactions associated with other portions of a requested workflow. These transactions may include, for example, opening an account, funding the account, issuing a digital payment card, and the like. The lows illustrated in FIGS. 9-15 are example versions of such flows at different levels of complexity, with the example of FIGS. 9-12 corresponding to a process that might be performed by/for a financial institution, and the flows of FIGS. 13-15 representing a simplified “demonstration” version of such a process.

FIG. 9 is a flow diagram 900 illustrating a portion of a workflow including issuance of a card to a user from a financial institution, according to an example embodiment. The flow diagram 900 may represent an example of proceeding once a “green” score is determined using process described above in conjunction with FIGS. 5-8. In the example shown, an integration platform may transmit a score to the workflow database 104, and transmit the end assessment score to the workflow service itself. The workflow integration plan may also notify the integration SDK 103, for example via the broker.

Based on the score being acceptable to proceed, the workflow service may initiate an acceptance of terms and conditions process in which the workflow service transmits an initiation of that process to the workflow integration platform. The workflow integration platform will create an event in the workflow database 104, and notify the integration SDK 103 via broker message and request/update arrangement. The retrieved information that the integration SDK 103 may include specific terms and conditions data which may include dynamic content. The integration SDK 103 may display a terms and conditions page within the context of a mobile application to a user, and transmit in response, to the workflow integration platform, acceptance of the terms and conditions. The acceptance of the terms and conditions is provided to both the flow database 104 and the workflow service. Notification of completion of submission is then to the integration SDK 103 via a broker message and request/update arrangement.

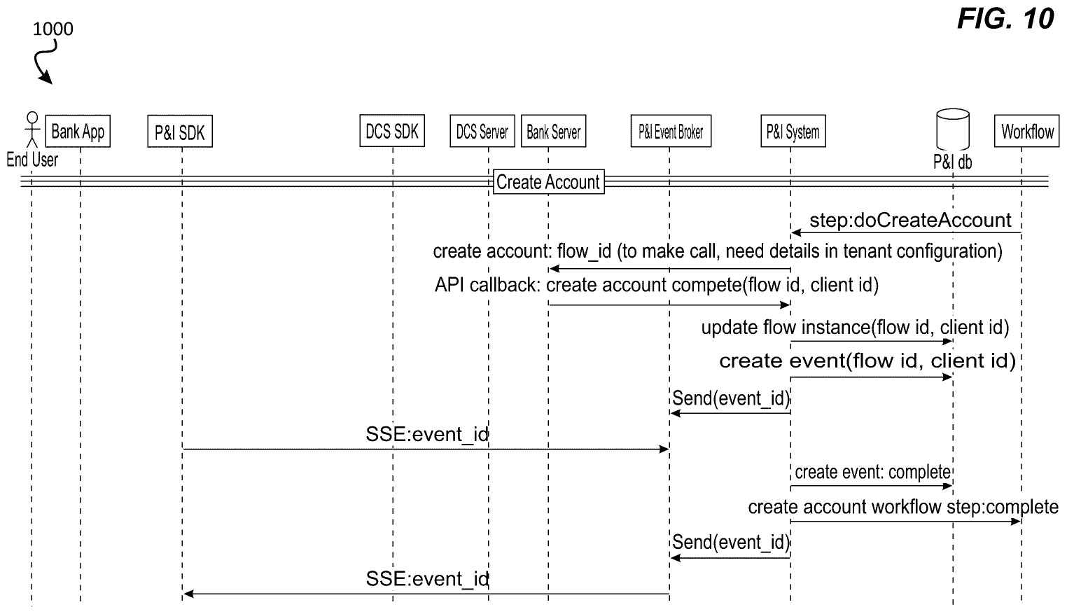

FIG. 10 is a flow diagram 1000 of a continued portion of a workflow implementing a financial institution initiation process including user acceptance of terms and conditions, according to an example embodiment. Specifically, the flow diagram 1000 illustrates creating an account once the user has accepted terms and conditions, as seen in FIG. 9. In particular, the workflow service will transmit a create account notification to the workflow integration platform, which will communicate with a bank server. Specifically, the workflow integration platform will transmit a create account message including specific details required by the financial institution to create the account. The message may be transmitted to a bank computing system API, and an API call back may return an indication of completion of the account creation including a flow identifier (indicating that this is part of the same overall workflow) and a client identifier confirming the user for whom the account is created. The workflow integration platform will transmit updated details regarding the workflow to the workflow database 104, and notify both the integration SDK 103 and the workflow service that the account creation is complete.

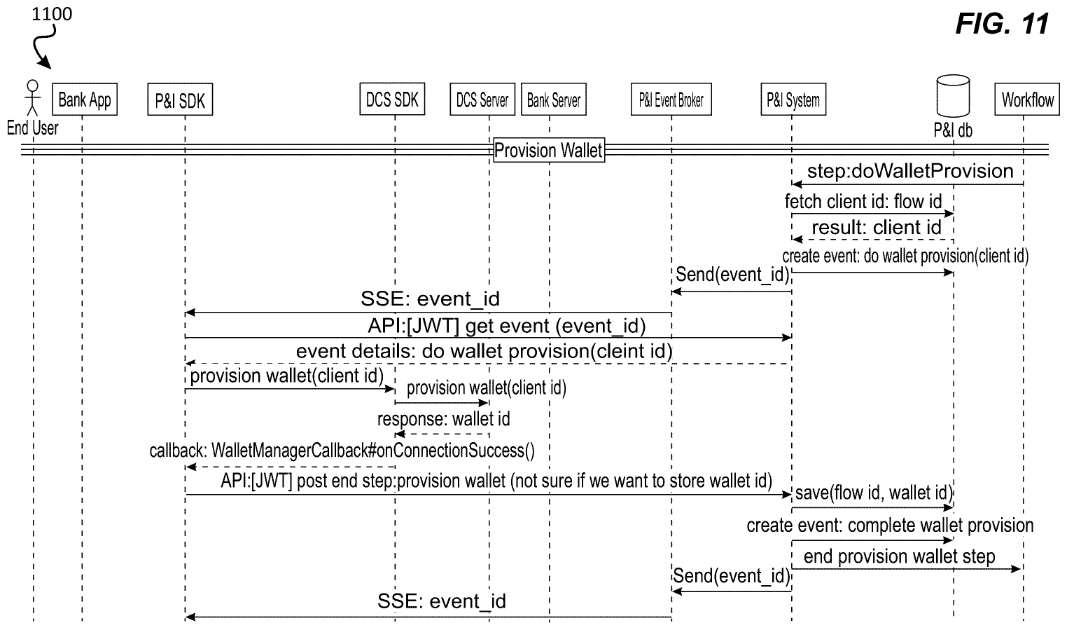

FIG. 11 is a flow diagram 1100 of a portion of a workflow implementing account creation and wallet provisioning processes within the financial institution initiation process, according to an example embodiment. Specifically, the flow diagram 1100 represents provisioning of a wallet upon creation and account as described above in conjunction with FIGS. 9-10. In particular, a workflow service will transmit a wallet provisioning message to the workflow integration platform. The workflow integration platform will obtain a client identifier based on a flow identifier, will store in the workflow database an indication that the current status of the account is that a wallet is being provisioned. The workflow integration platform will notify the integration SDK 103 of an event, and upon receipt of a request from that SDK to retrieve data, the workflow integration platform will provide a wallet provisioning command to the SDK alongside the client identifier.

Exemption, the integration SDK will transmit a command to provision a wallet, alongside a client identifier, to a digital card services SDK (e.g., DCS SDK 121, or another type of SDK either integrated into the mobile application or otherwise made available by a digital card issuance system). The digital card services SDK will relay a command to digital card services server (e.g. the digital card issuance system 120 of FIG. 1), and will receive in response a wallet identifier of the created wallet. The digital card services SDK will return a notification to the integration SDK that the wallet creation was a success. The integration SDK will send a message back to the workflow integration platform that the wallet had been provisioned.

In some instances, the integration SDK will receive the wallet identifier from the digital card services SDK. In such instances, the integration SDK can provide the wallet identifier to the workflow integration platform, which will store the wallet identifier in the workflow database. The workflow integration platform will also save an event completion status in the workflow database, and provide a notification to the workflow services indicating that the wallet provisioning step has been completed. A confirmation may be sent back to the integration SDK as well via the broker message and request/update arrangement previously described.

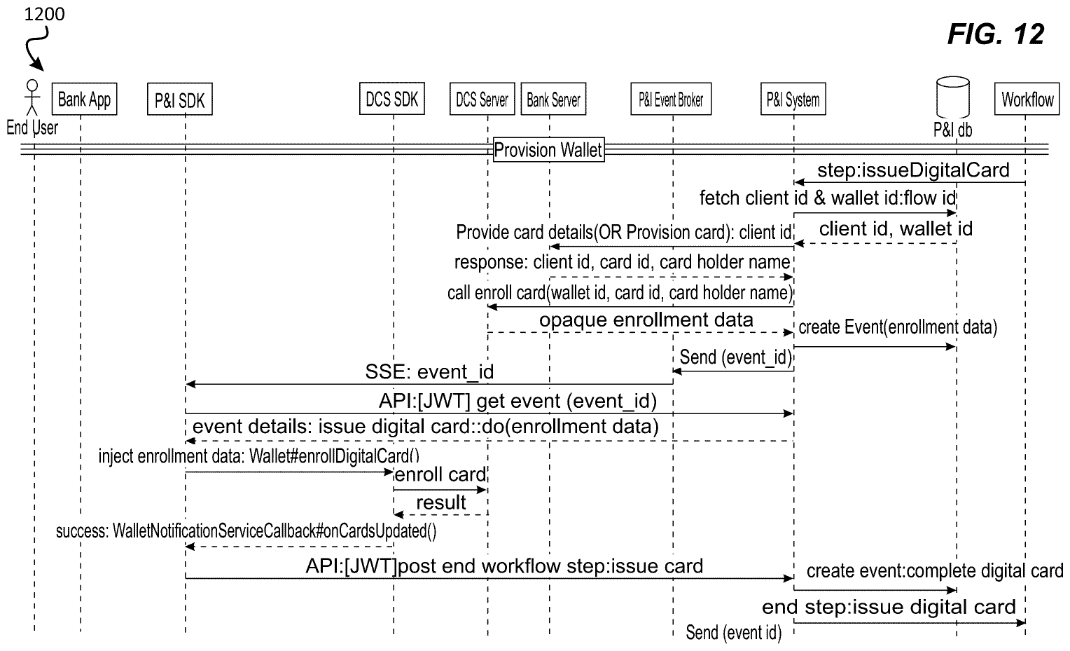

FIG. 12 is a flow diagram 1200 of a portion of a workflow including issuance of a card to a user from a financial institution, within the financial institution initiation process, according to an example embodiment. In this example, the workflow may include a step of issuing a digital card to the user. Accordingly, the workflow service may send to the workflow integration platform a notification that such a step should occur. The workflow integration platform will retrieve a client identifier and wallet identifier from the workflow database and transmit to a bank server (e.g., account/card issuer 110, which in the illustrated example is a financial institution) a request for card details or card provisioning based on a client identifier. The bank server may respond with a client identifier, card identifier, and cardholder name, which the workflow integration platform may provide to the digital card services server (e.g. the digital card issuance system 120 of FIG. 1). The digital card services server may return enrollment data to the workflow integration platform, which may store the data in the workflow database 104. The workflow integration platform may then transmit, via the broker notification/request arrangement previously described, and enrollment requests to the integration SDK 103 including the enrollment data received from the digital card services server.

In some instances, the card issuance processes performed herein may result in issuance of a digital payment card that may be maintained within a mobile wallet, for example within the mobile application 30. In other instances, the card issuance process may correspond to an instant issuance process during which a physical card may be issued to a customer in response to such a workflow. Physical card issuance could be facilitated by integrating an instant financial issuance service into the plurality of services available via network 10.

The integration SDK 103 may transmit a message injecting enrollment data to the digital card services SDK, which may act to enroll the card with the digital card services server. The digital card services server may return a results to the digital card services SDK, which returns a success notification back to the integration SDK 103. The integration SDK 103 may then transmit a workflow completion message indicating that the card has successfully been issued back to the workflow integration platform, which in turn stores a status of digital card issuance in the workflow database, and returns such a notification to the workflow service.

Referring now to FIGS. 13-15, a similar process to that shown in FIGS. 9-12 is briefly described. In this example set of flows, rather than use of an integration SDK, a demonstration application is used, simplifying the process. It is noted that rather than a demonstration application, a financial institution application may simply integrate functionality of the integration SDK 103 natively within the mobile application 30.

In the example flow diagram 1300 shown in FIG. 13, upon receiving an indication that the identity verification process overall score is acceptable (e.g. the risk score is “green”), a workflow integration platform may transmit a score to the workflow database 104, and transmit the end assessment score to the workflow service itself. The workflow integration plan may also notify the mobile application, for example via the broker (similar to FIG. 9).

Based on the score being acceptable to proceed, the workflow service may initiate an acceptance of terms and conditions process in which the workflow service transmits an initiation of that process to the workflow integration platform. The workflow integration platform will create an event in the workflow database 104, and notify the mobile application via broker message and request/update arrangement. The retrieved information may include specific terms and conditions data which may include dynamic content. The mobile application will display a terms and conditions page to a user and transmit in response, to the workflow integration platform, acceptance of the terms and conditions. The acceptance of the terms and conditions is provided to both the flow database 104 and the workflow service. Notification of completion of submission is then to the mobile application via a broker message and request/update arrangement.

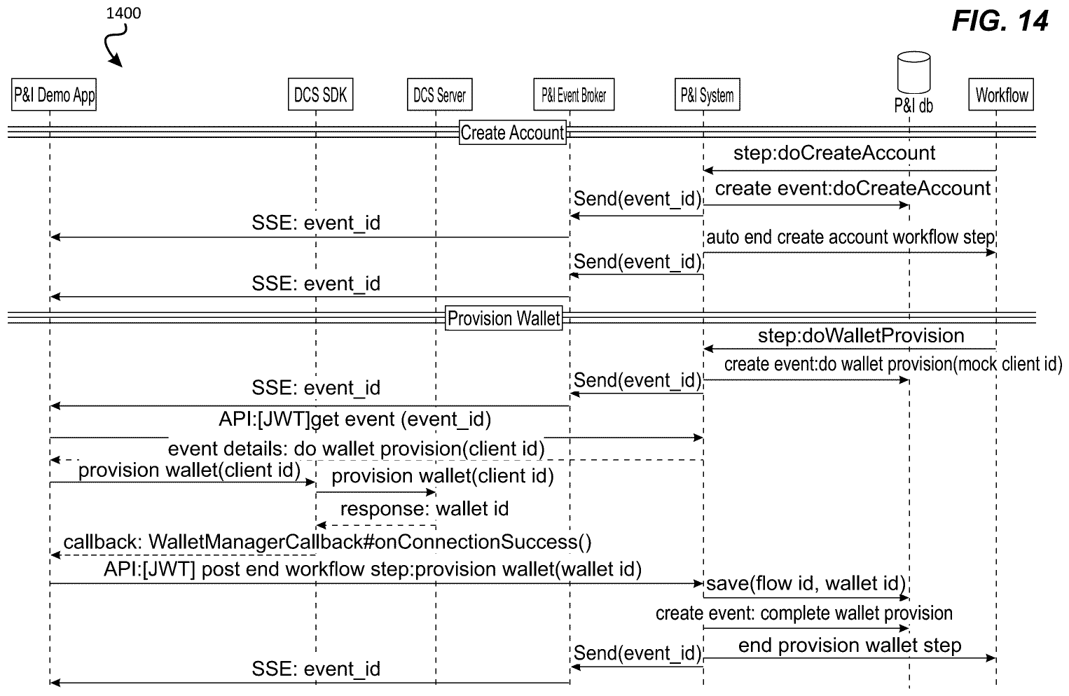

FIG. 14 is a flow diagram 1400 of a portion of a workflow including creation of the account at a financial institution, continuing from the flow diagram 1300 of FIG. 13. In this example specifically, account creation and wallet provisioning are provided, similarly to those processes seen in FIGS. 10-11, above.

In the flow 1400, the workflow service will transmit a create account notification to the workflow integration platform, which will communicate with a bank server. Specifically, the workflow integration platform will transmit a create account message including specific details required by the financial institution to create the account. The message may be transmitted to a bank computing system API, and an API call back may return an indication of completion of the account creation including a flow identifier (indicating that this is part of the same overall workflow) and a client identifier confirming the user for whom the account is created. The workflow integration platform will transmit updated details regarding the workflow to the workflow database 104, and notify the mobile application and the workflow service that the account creation is complete.

During wallet provisioning, the workflow service will transmit a wallet provisioning message to the workflow integration platform. The workflow integration platform will obtain a client identifier based on a flow identifier, and will store in the workflow database an indication that the current status of the account is that a wallet is being provisioned. The workflow integration platform will notify the mobile application of an event, and upon receipt of a request from that mobile application to retrieve data, the workflow integration platform will provide a wallet provisioning command to the mobile application alongside the client identifier.

In this example the mobile application will then transmit a command to provision a wallet, alongside a client identifier, to a digital card services SDK (e.g., DCS SDK 121, or another type of SDK either integrated into the mobile application or otherwise made available by a digital card issuance system). The digital card services SDK will relay a command to digital card services server (e.g. the digital card issuance system 120 of FIG. 1), and will receive in response a wallet identifier of the created wallet. The digital card services SDK will return a notification to the mobile application that the wallet creation was a success. The mobile application will send a message back to the workflow integration platform that the wallet had been provisioned.

In some instances, the mobile application will receive the wallet identifier from the digital card services SDK. In such instances, the mobile application can provide the wallet identifier to the workflow integration platform, which will store the wallet identifier in the workflow database. The workflow integration platform will also save an event completion status in the workflow database, and provide a notification to the workflow services indicating that the wallet provisioning step has been completed. A confirmation may be sent back to the mobile application as well via the broker message and request/update arrangement previously described.

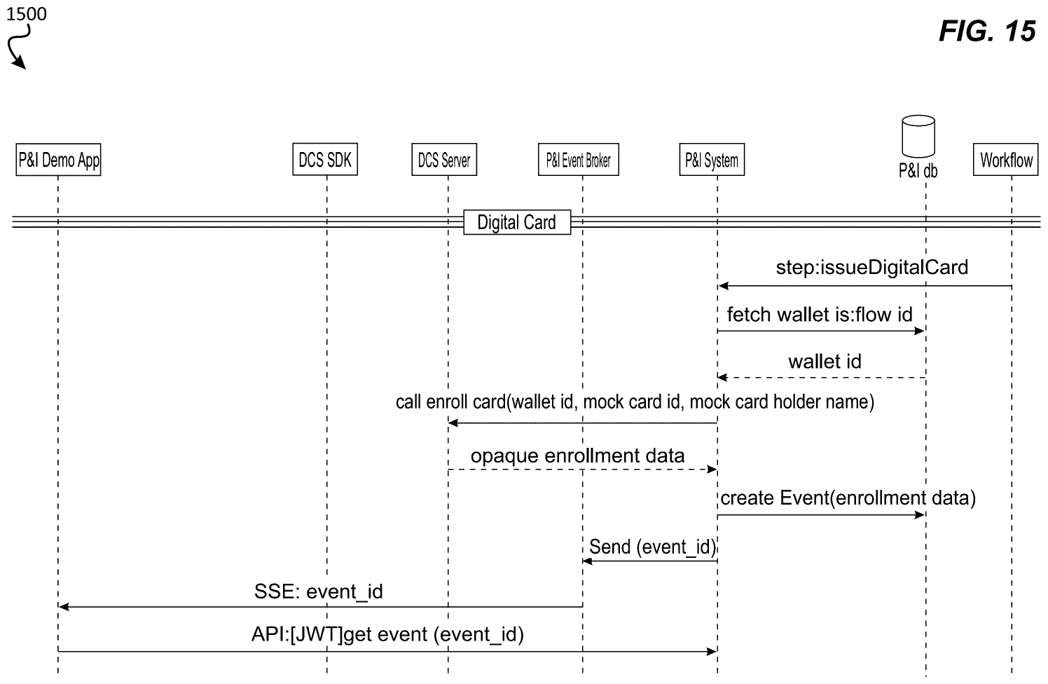

FIG. 15 is a flow diagram 1500 of a portion of a workflow including provisioning a digital wallet for a customer of a financial institution, according to an example embodiment. In this example, the workflow may include a step of issuing a digital card to the user. Accordingly, the workflow service may send to the workflow integration platform a notification that such a step should occur. The workflow integration platform will retrieve a client identifier and wallet identifier from the workflow database and transmit to a bank server (e.g., account/card issuer 110, which in the illustrated example is a financial institution) a request for card details or card provisioning based on a client identifier. The bank server may respond with a client identifier, card identifier, and cardholder name, which the workflow integration platform may provide to the digital card services server (e.g. the digital card issuance system 120 of FIG. 1). The digital card services server may return enrollment data to the workflow integration platform, which may store the data in the workflow database 104. The workflow integration platform may then transmit, via the broker notification/request arrangement previously described, and enrollment requests to the mobile application, including the enrollment data received from the digital card services server.

The mobile application may transmit a message injecting enrollment data to the digital card services SDK, which may act to enroll the card with the digital card services server. The digital card services server may return a result of the enrollment to the digital card services SDK, which returns a success notification back to the mobile application. The mobile application may then transmit a workflow completion message indicating that the card has successfully been issued back to the workflow integration platform, which in turn stores a status of digital card issuance in the workflow database, and returns such a notification to the workflow service.

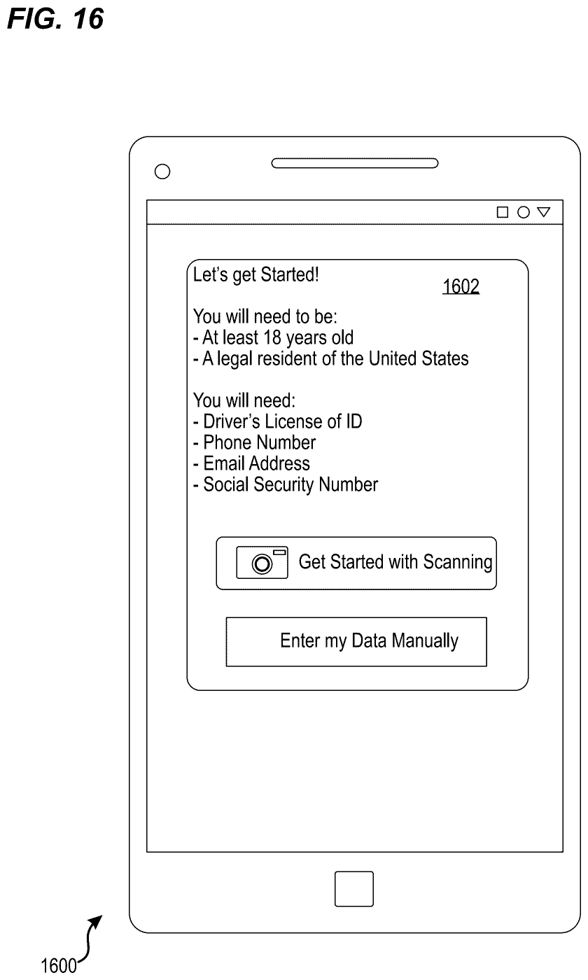

Referring now to FIGS. 16-28, a series of user interfaces and a workflow is illustrated which may utilize the messaging flow described above to accomplish an integrated card application and issuance process using integrated identity and payment services via the workflow integration platform described herein. Generally speaking, the workflow that is made available by the workflow integration platform is flexible to allow variations on the user process while independently managing a state of a workflow across a plurality of services, thereby enabling significant flexibility to end users in how a workflow may be accomplished despite the need for coordination of back-end services that would typically be tightly coupled and/or sequentially accessed.

In examples, the user interfaces and workflow of FIGS. 16-28 correspond generally to the workflow illustrated above in conjunction with FIGS. 5-8, in which one or more back end identity verification services may be accessed prior to submission to a card issuance system. Such back end identity verification services may include, for example, any of services 12-20 described above in conjunction with FIGS. 1 and 2. The workflow integration server manages access to such services in conjunction with a workflow to allow users to seamlessly execute a workflow while accessing different back-end services in response to user operations.

FIG. 16 is a schematic depiction of a graphical user interface 1600 displayed on a mobile device as part of a digital card issuance process, in accordance with an example embodiment. The graphical user interface 1600 presents an initial screen 1602 that allows a user to select between capturing user information manually or extracting relevant user information from an identification document.

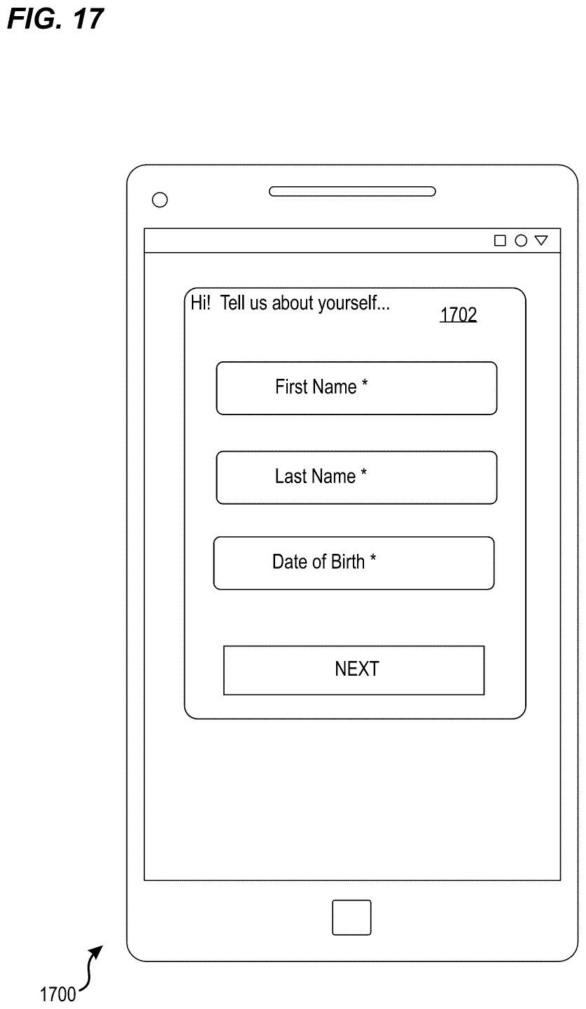

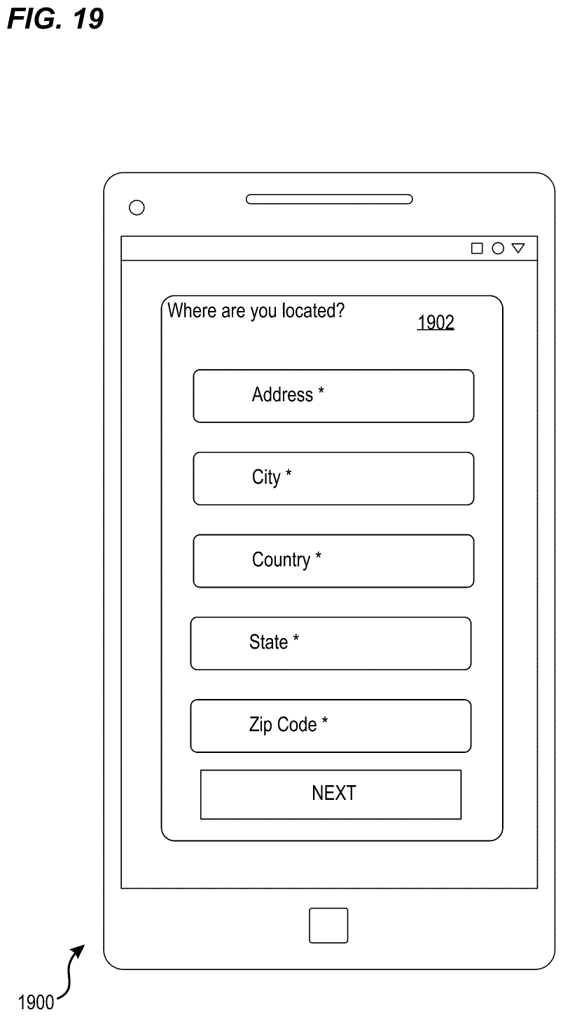

FIGS. 17-19 illustrate graphical user interfaces useable to capture information manually from a user, for example in the event a user selects capture of user information manually within the initial screen 1602 of FIG. 16. In FIG. 17, a graphical user interface 1700 depicts a screen region 1702 in which user information, such as biographical information (first name, last name, and date of birth) is captured. Upon selection of a “Next” button, graphical user interface 1800 may present a screen region 1802 in which communication information (e.g., email address and mobile phone number) may be received. Upon selection of a “Next” button within that screen region 1802, a further user interface 1900 depicted in FIG. 19 may present a screen region 1902 in which location information is captured (address, city, state, ZIP code, and the like).

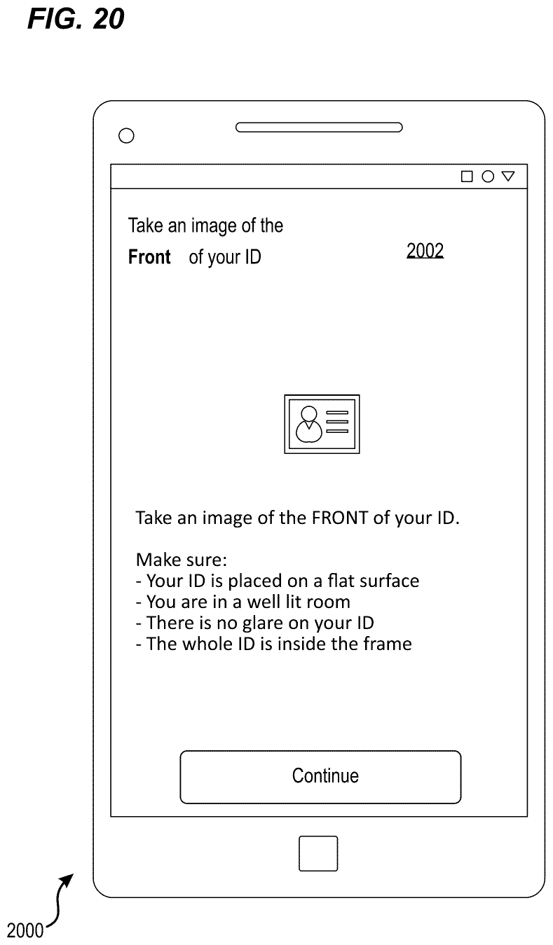

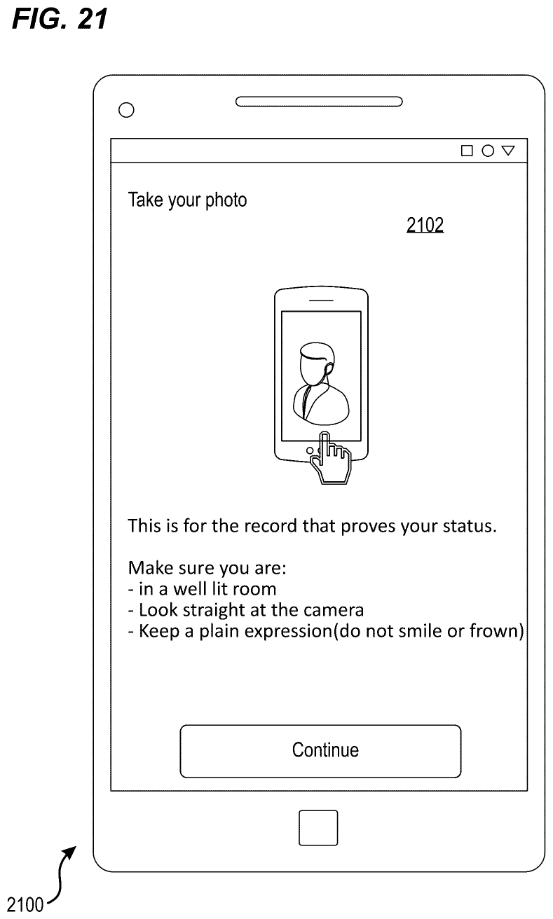

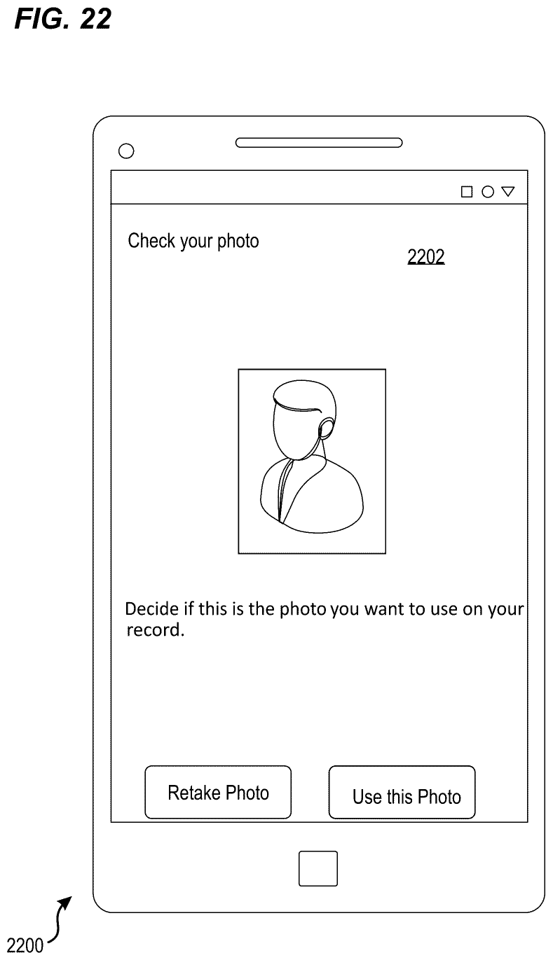

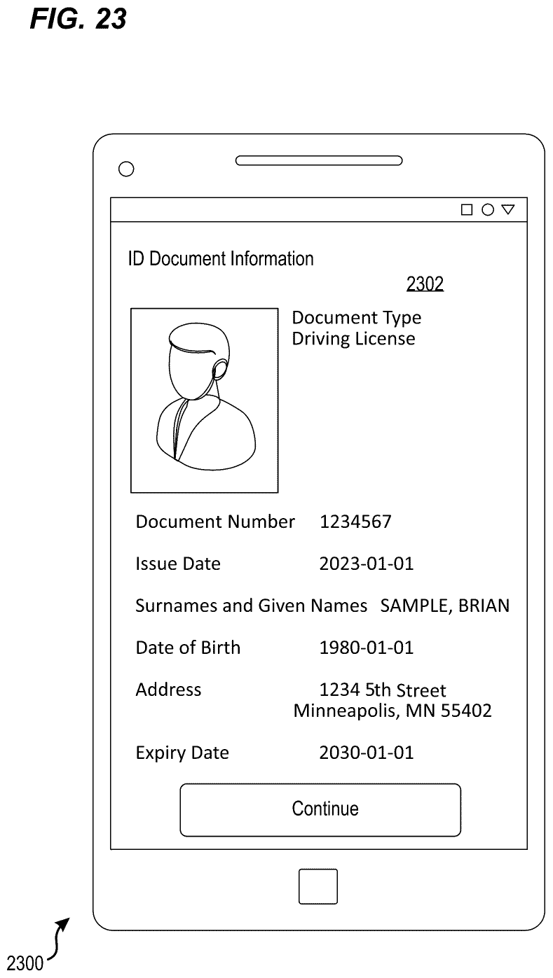

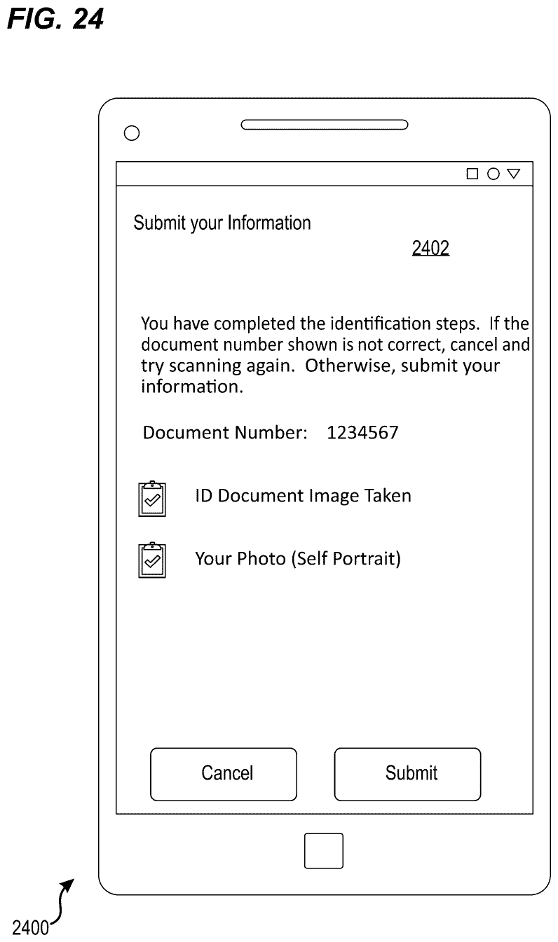

FIGS. 20-24 illustrate graphical user interfaces useable to capture information from an identification document of a user. By a user selecting this option (e.g., within the user interface 1600 of FIG. 16), different back-end services may be used by the workflow integration platform to achieve an analogous overall workflow result. In particular, FIG. 20 illustrates a graphical user interface 2000 for automatic capture of information from an identification card, and displays an instruction region 2002 presenting instructions to the user for capture of image information. Upon selection of the “Continue” option, the user may be prompted with a camera screen, for example with one or more image guides, to assist in capturing an image of an identification document. Once the identification document is captured, a back-end service may be used to extract user details from that document. FIG. 21 illustrates a user interface 2100 for instructing a user to capture a self-portrait, and includes an instruction display region 2102. Upon selection of the “Continue” option, the user may again be prompted with a camera screen, for example to capture a self-portrait (“selfie”) to be used for, e.g., validation of user identity and optionally on a given digital identification or payment card. FIG. 22 illustrates a user interface 2200 allowing a user to validate the self-portrait photo taken, and a user may be prompted to either accept or retake such a photo. Upon acceptance of a photo, a confirmation screen 2300 may be displayed as seen in FIG. 23, including a display region 2302 depicting the captured photo as well as user details extracted from the identification document image that was previously captured. A submission user interface 2400 seen in FIG. 24 allows a user to either cancel submission or confirm submission of the card application within a submission display screen 2402, after receiving confirmation in the confirmation screen 2300.

If the user cancels submission, the process may be terminated by the workflow integration platform at this point, and submission to a back end card service may never occur. However, if the user does proceed, the accesses to various back-end services by the workflow integration platform may result in capture of various information in association with a session identifier, and the session information captured from the user may be submitted to a card issuance service, for example for issuance of a virtual card. In this case, a series of user interfaces may be presented, via the workflow integration platform, for capture of additional information needed by such a back-end service, and for confirming submission thereto.

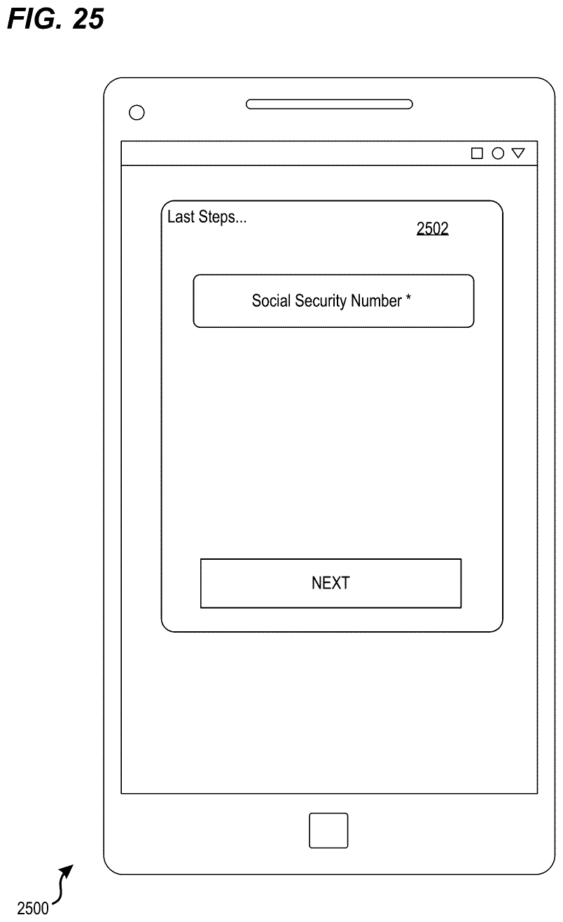

In particular, in the example shown, a series of user interfaces are seen in FIGS. 25-27 depicting submission of data to a card issuance service. FIG. 25 illustrates a user interface 2500 for collecting a social security number of a user within a display screen 2500; this information is not typically accessible from a user's identity document but may be required for a payment card application, so would be separately collected. A user interface 2700 may present a set of terms and conditions in a screen 2702 to the user, and may present that user with the option to accept or decline such conditions. If the user declines the conditions, they may again terminate the process of applying for a payment card via a workflow. If the user accepts the terms and conditions, the captured information may be submitted to a card issuance service. A user interface 2700 may present a PIN code capture screen 2702, in which a user may set a PIN code securing access to his/her payment card details once a virtual payment card is issued.

Although the screens and user interfaces are described above in a particular order, the order or arrangement of such screens may change, consistent with the present disclosure. That is, a different workflow may be defined in which different flow of screens is used. In such a case, the workflow integration platform will manage a session identifier of the user, coordinate next steps of accessing back end identity and identity verification services, signature services, and the like, as well as submission of details to a card issuance service, based on workflow logic maintained at the workflow integration service. As such, the underlying services do not need to maintain state of the workflow, and as user selections change, the workflow integration platform may manage access of different integrated services and present different screens to the user.

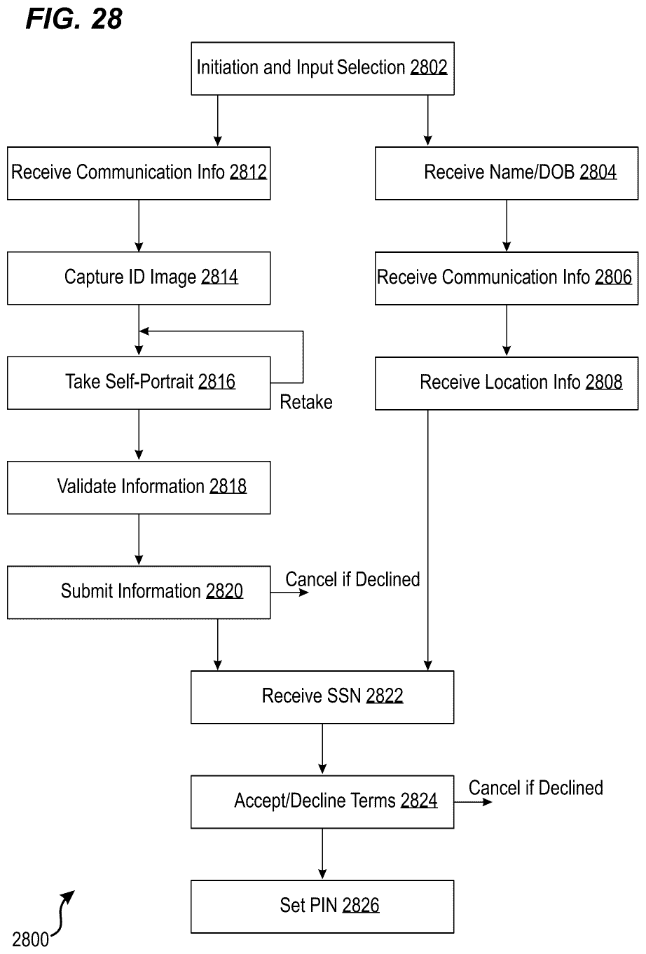

FIG. 28 is a flowchart of an example method 2800 of use of the one or more user interfaces presented in accordance with the workflow integration platform as part of a card issuance process. As illustrated, the method 2800 may be performed using the workflow integration platform described herein, and represents one possible ordering of workflow steps as may be implemented using the user interfaces of FIGS. 16-27.

In the example shown, the method includes initiation of a workflow and selection of an input type (step 2802). The selection of the input type may be between manual entry and capture of user data from a user identification document.

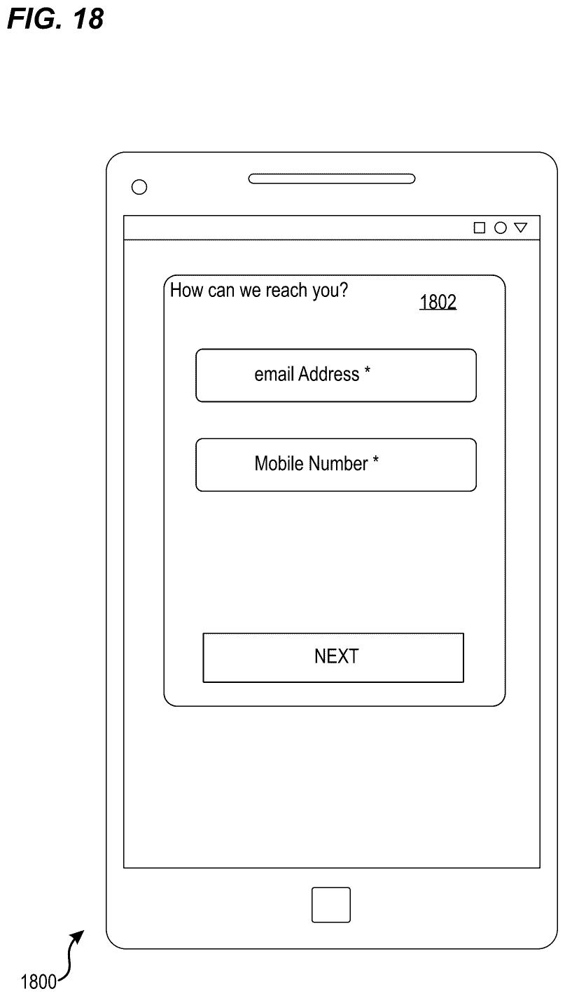

In the instance the user selects manual entry, the method 2800 may include receiving, from user entry in a form, a name and date of birth of the user (step 2804). An example user interface for acquiring this information is illustrated in FIG. 17. The method 2800 may also include receiving communication information (step 2806), as seen in FIG. 18. This may include receiving an email address and a mobile telephone number that may be used to contact the user, or for second factor authentication purposes. The method may also include receiving location information, such as city, state, and ZIP Code (step 2808), as seen in FIG. 19.

It is noted that the user interfaces of FIGS. 17-19 may be modified, and the order of acquiring this information may change based on a definition at the workflow integration platform. That is, there is no particular limitation on ordering of screens or appearance of screens, other than that a card issuer may require a particular data set to be in place prior to approval of card issuance. The order of accessing various precursor services, such as identity as a service, identity verification is a service, signature as a service, and the like are not so limited. Furthermore, individual third parties wishing to implement a workflow using the workflow integration platform may define a particular appearance of a user interface, for example a branding, logos, and the like.

Referring back to step 2802, if a user selects capture of user data from a user identification document, the method 2800 may include receiving communication information (step 2812). This may include receiving an email address and/or a mobile telephone number as discussed above. The method 2800 may also include capturing an image of an identification document (step 2814); this may be performed by using a camera of a mobile device, and may be guided using screens as depicted in the user interfaces of FIG. 20.

Continuing this example, a user may then be guided to take a self-portrait using a camera of the mobile device (step 2816); the user may optionally be afforded the opportunity to retake the self-portrait until satisfactory. Examples of such user interfaces guiding self-portrait capture are illustrated in FIGS. 21-22. Once the image of the identification document and the self-portrait are captured, the user may be provided the opportunity to validate the information extracted from the identification document (step 2818), as seen in FIG. 23. Upon confirmation (e.g., via a confirmation screen in FIG. 24), the user may submit that information, indicating that identity verification may now take place within a back end service as managed by the workflow integration platform. The user may opt to cancel the submission, thereby causing the image of the identification document and the self-portrait to be discarded.

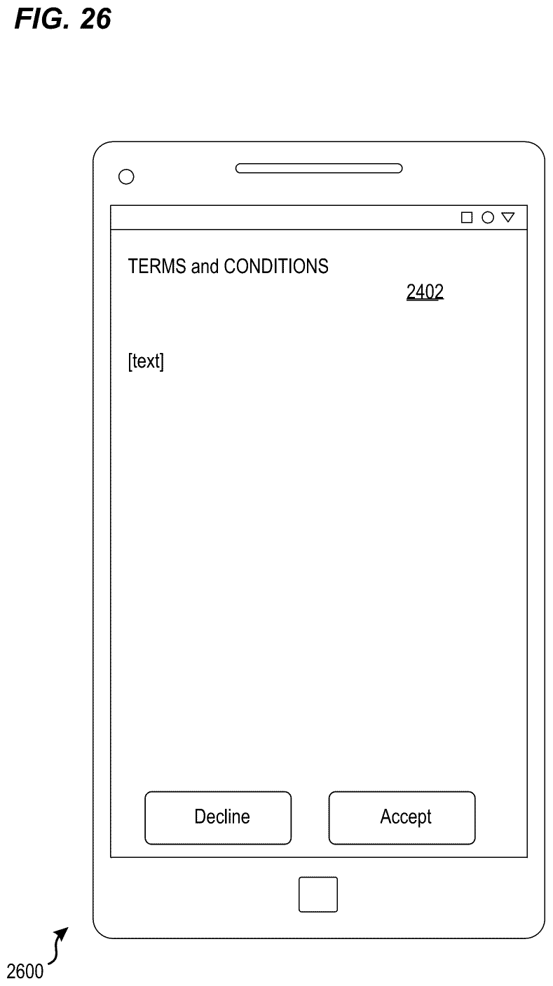

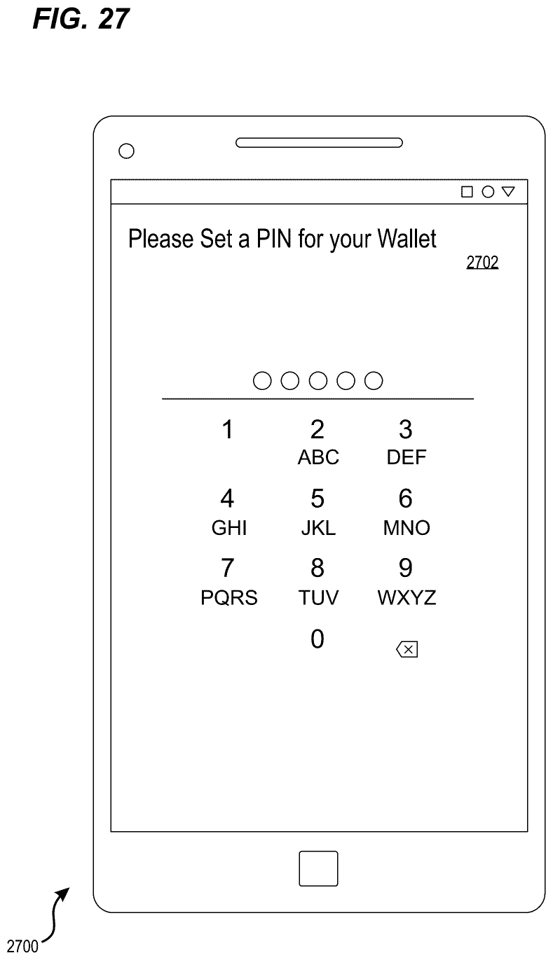

At this point, regardless of whether manual entry or identification document based information gathering is performed, a Social Security number or other unique identifier may be requested from the user (at step 2822), as seen in FIG. 25. The user may be presented with one or more terms they can accept or decline (step 2824), as seen in FIG. 26, and upon submission, may be prompted to create a PIN code for use in accessing a virtual payment card that may be issued thereafter (step 2826), as seen in FIG. 27.

Referring to FIGS. 16-28 generally, and as discussed previously, it may be possible that, for a given workflow, it is desired to change the information that is gathered, for example by adding an additional data field to a particular user interface and retrieve additional information from a user. This may be managed at the workflow integration platform through definition of the workflow, and may be entirely independent of an end user institution of the workflow management server (e.g., a financial institution using such a workflow to issue virtual payment cards). Furthermore, and referring to an overall process, the workflow integration platform may be used to adjust various thresholds that are used in determining whether a process is allowed to proceed. For example, based on the user identification information captured, and identity verification service may be called, which returns a confidence of user identity. The threshold for that confidence may be defined within the workflow integration platform, and may be adjustable by an end-user institution according to that institution's risk tolerance.

### II. PHYSICAL AND DIGITAL ID CARD ISSUANCE

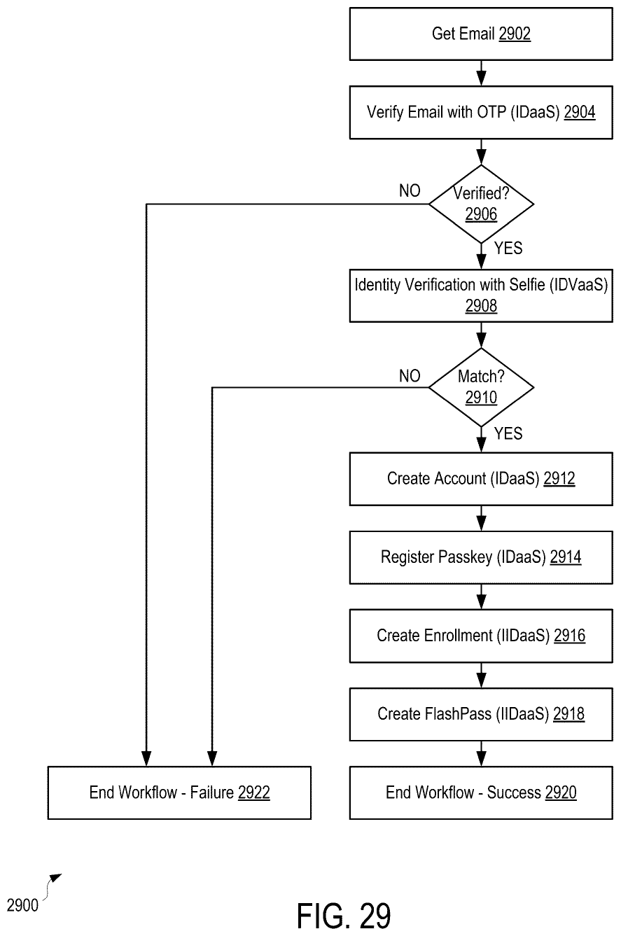

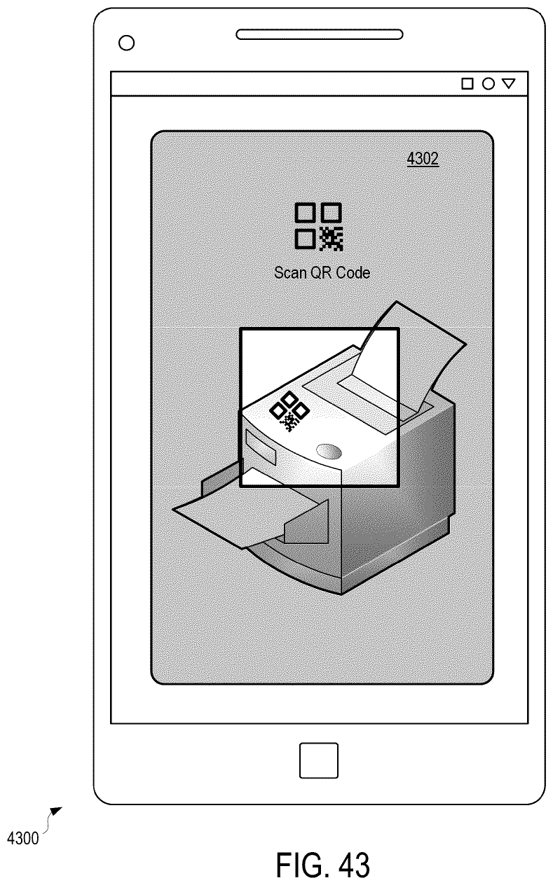

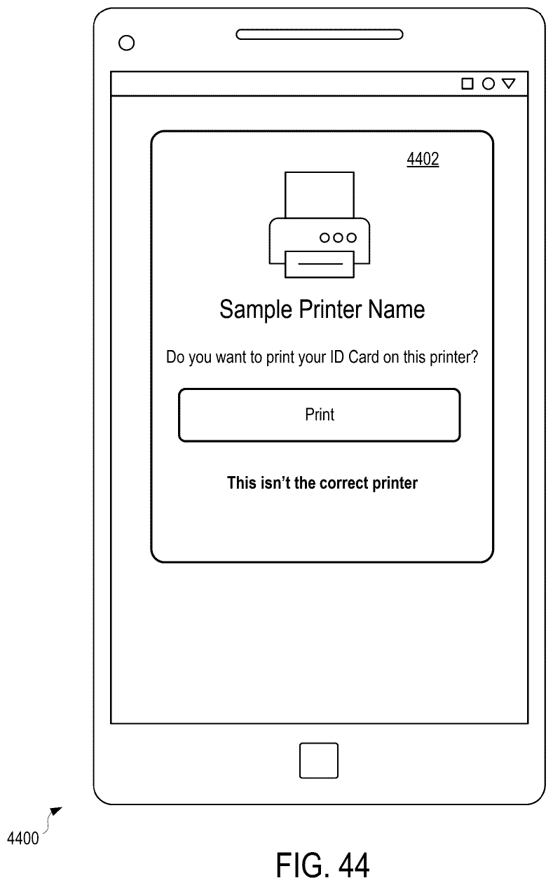

Turning now to FIGS. 29-45, examples of the workflow integration platform in the context of issuing digital and physical ID cards are described. In an example, the ID cards are issued to students at an academic institution. Alternative examples in which the workflow integration platform may be used for issuing ID cards includes issuing the ID cards to employees of a company, visitors at a consumer event, customers of a financial institution, or the like.

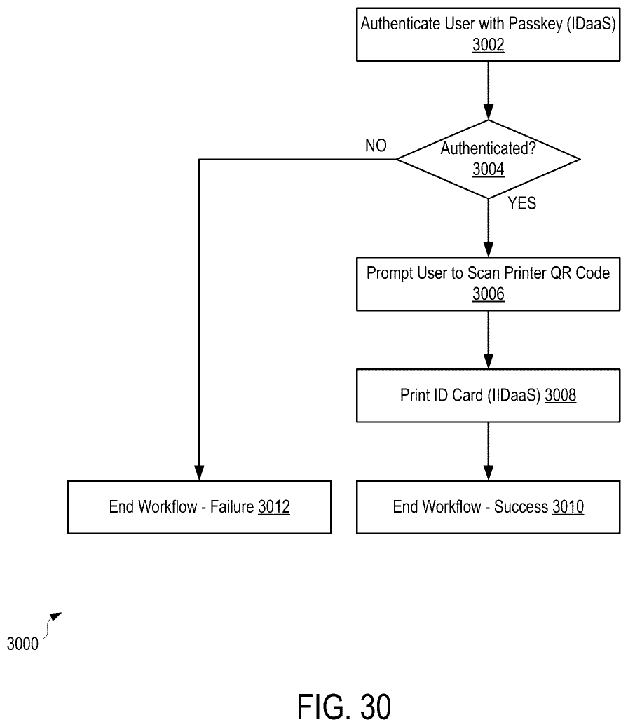

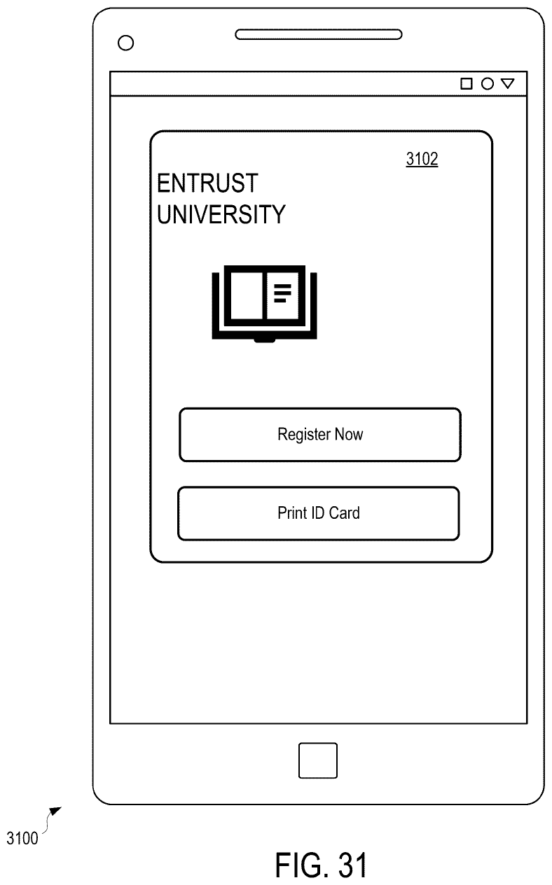

FIGS. 29 and 30 illustrate flowcharts or example methods 2900, 3000 in for issuing digital and physical ID cards. The method 2900 illustrated in FIG. 29 may be performed by the workflow integration platform to register a user and issue a digital ID card. As illustrated, the method 2900 may be performed using the workflow integration platform described herein, and represents one possible ordering of workflow steps as may be implemented using the user interfaces of FIGS. 31-40. The workflow integration platform coordinates use of a plurality of underlying services in executing the workflow in a similar manner to the payment card example described above, including management of identity as a service (IDaaS), identity verification as a service (IDVaaS), instant identity as a service (IIDaaS), and various other services including signature services or other stand-alone platform services that may be coordinated by a workflow integration platform into an overall workflow to meet a particular use case (in this instance, physical and digital identity card issuance).

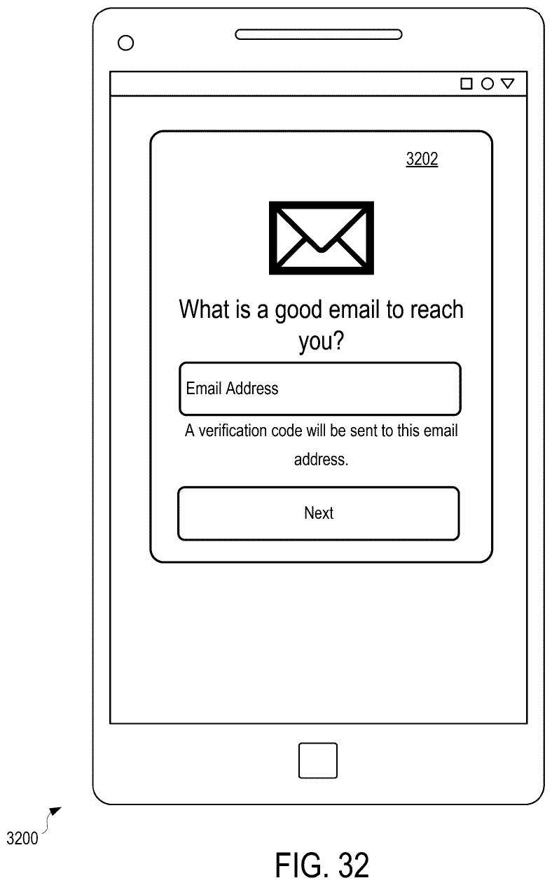

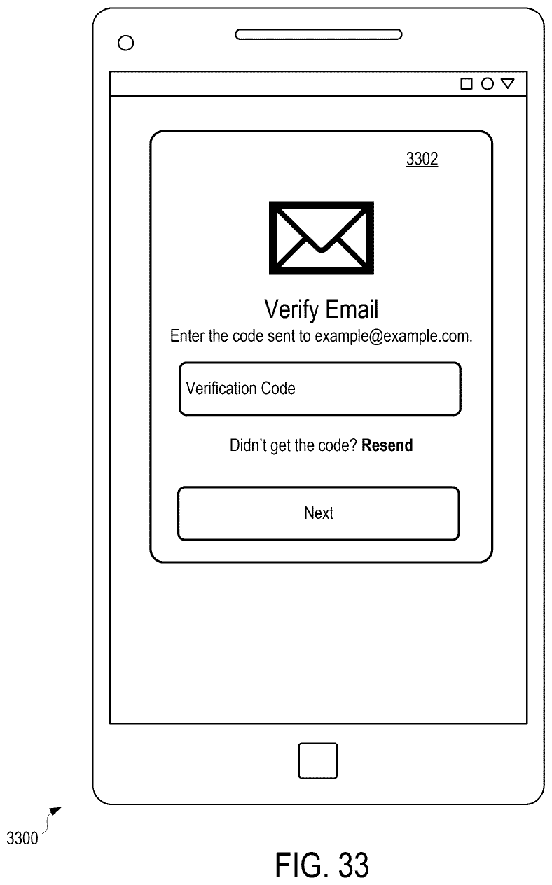

In the example shown the method 2900 includes receiving an email address from a user (step 2902). An example user interface for acquiring this information is illustrated in FIG. 32. The email address message is routed via the workflow integration platform to, and validated using, an IDaaS service by sending a one-time password to the user using the received email address and confirming that the user enters the one-time password (step 2904). An example user interface for verifying a user's email address using the one-time password is illustrated in FIG. 33. Other procedures may additionally or alternatively be performed to validate the email address entered by the user. For example, when the user is registering for a student ID at an academic institution, the email address may be validated against a list of email addresses for active students to confirm that the user is a student at the academic institution before issues a student ID card to the user.

In alternative embodiments, other forms of contact information may be received from the user and verified in steps 2902 and 2904. Additionally, in further embodiments, other methods are used to validate the contact information entered by the user.

If the email address entered by the user is verified (step 2406), the method 2900 includes performing identity verification with a self-portrait using a IDVaaS service (step 2908). This may include submission of a self-portrait via the workflow integration platform to the IDVaaS service for verification, including management of request and response flows via the workflow integration platform. If the email address is not verified, based on the definition of the workflow, the method 2900 ends and the user is not registered (step 2922).

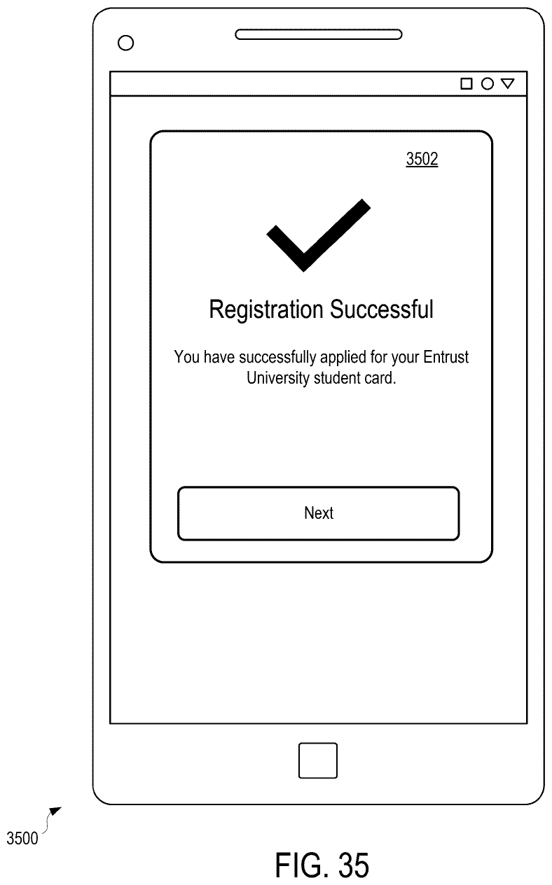

In an embodiment, identity verification (step 2908) is performed by comparing the self-portrait to an image of the user on an identification document. For example, in addition to taking a self-portrait, the user may also scan an identification document, and information on the identification document-including the image of the user—is extracted. The IDVaaS service may be called by the workflow integration platform to compare the self-portrait captured by the user against the image of the user from the identification, and if the images match (step 2910), the method 2900 continues, resulting in creation of an account for the user (step 2912). An example user interface displayed upon verification of the user identity is illustrated in FIG. 35. If the images do not match, the IDVaaS service may return a message indicating as such, and as defined in the workflow, the method 2900 ends and the user is not registered (step 2922). In an example, a similarity score is determined by comparing the two images. If the similarity score is above a threshold, the images are considered to be matching, and if the similarity score is below the threshold, the images are considered to not be matching. Examples of user interfaces for guiding self-portrait capture and scanning of an identification document are substantially similar to the user interfaces depicted in FIGS. 20-24, described above.

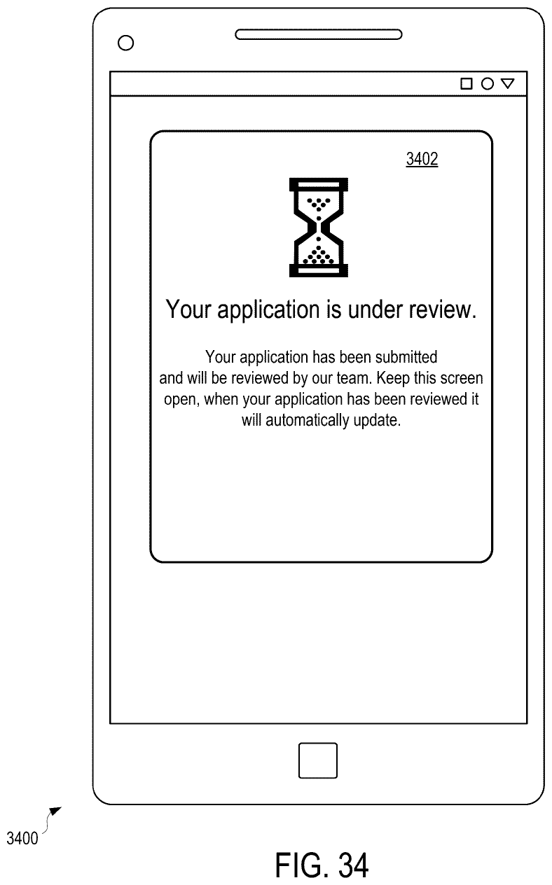

In alternative embodiments, if the IDVaaS service determines that the images do not match (i.e., the similarity score is below a threshold), the workflow may define an alternative option in which an administrator may manually compare the images to determine if the images match, and the administrator may verify the user. FIG. 34 illustrates an example user interface presented when the images are undergoing manual verification.

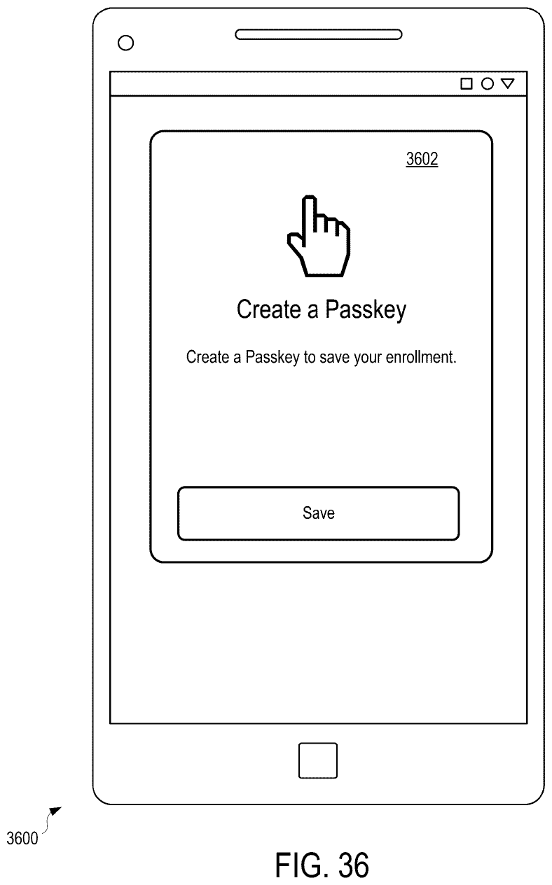

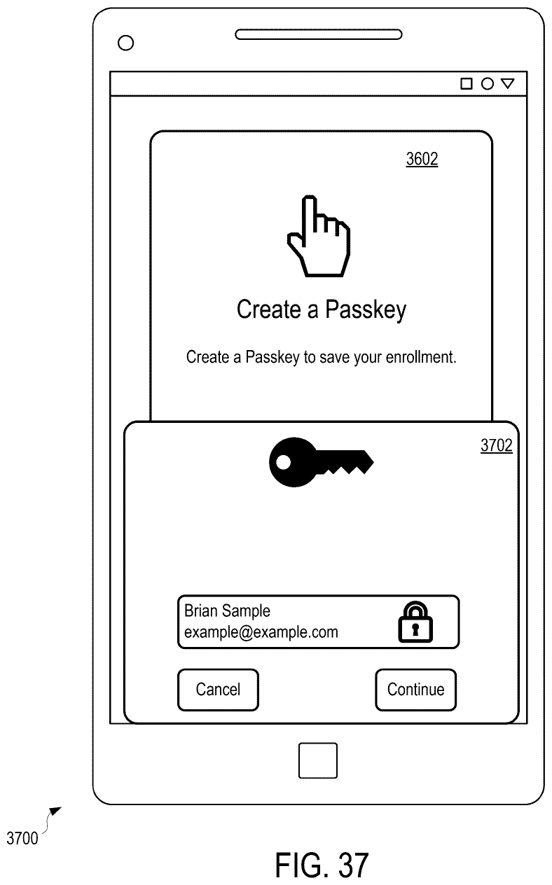

The user account is created within an IDaaS service (step 2912). In an embodiment, the IDaaS services is passed (via the workflow integration platform), and the user account in the IDaaS service includes, the information entered by the user and extracted from the user's identification document during steps 2902-2910. Additionally, a passkey is created and registered with the user account in the IDaaS service (step 2914). In an embodiment, the passkey includes a public key and a private key. The public key may be stored on the mobile device of the user (e.g., mobile device 50)—for example, in a keystore (e.g., keystore 320 of the mobile device)—and the public key may be stored with the IDaaS service. In examples, when the passkey is created, the user provides biometric information—such as a fingerprint or a facial identification—and the private key stored on the mobile device is only accessible when the user is authenticated using the provided biometric information. FIGS. 36 and 37 illustrate example user interfaces for creating and registering the passkey.

An enrollment in an IIDaaS service is also created for the user (step 2916). In embodiments, the enrollment includes information needed to issue an ID card for the user. For example, if the ID card is a student ID card, the enrollment may include a name, a student ID number, and a photo of the user. The enrollment may be used to create a digital ID card (step 2918). In embodiments, the IIDaaS service defines a template for issued ID cards and uses the information from the enrollment to create the ID card according to the defined template. After the digital ID card is issued, the method 2900 ends (step 2920).

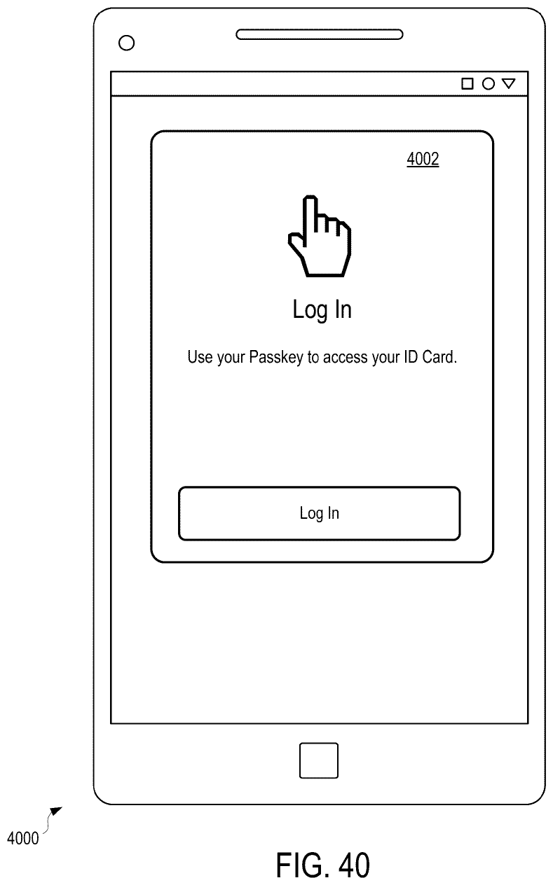

The enrollment in the IIDaaS service may also be used to issue a physical ID card. The method 3000 illustrated in FIG. 30 may be performed or coordinated by the workflow integration platform to issue a physical ID card to the user that was registered using the method 2900 shown in FIG. 29. As illustrated, the method 3000 may be performed, at least in part, using the workflow integration platform described herein, and represents one possible ordering of workflow steps as may be implemented at that platform and using the user interfaces of FIGS. 40-45.

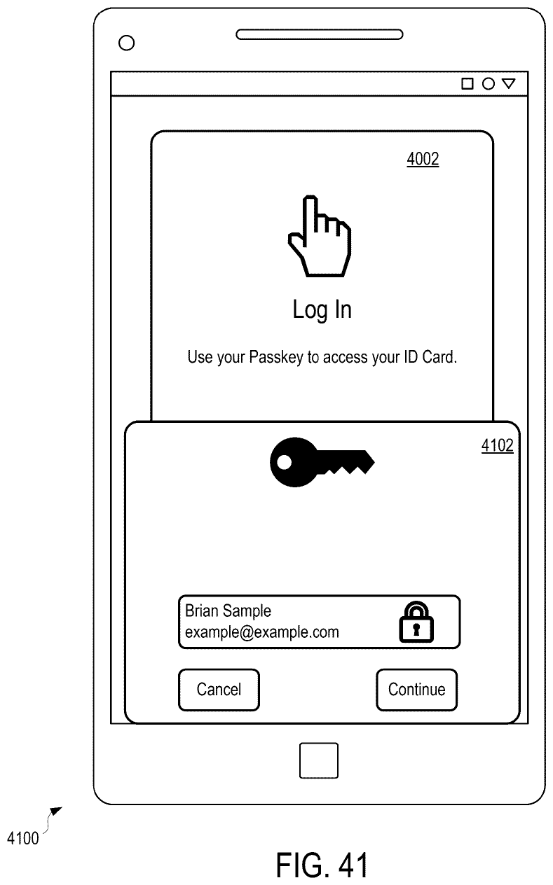

In the example embodiment shown, the user is authenticated using the previously created passkey through the IDaaS service (step 3002). In an embodiment, the IDaaS issues a challenge that is sent to the user's mobile device storing the private key of the passkey. Upon receiving the challenge, the user uses biometric information to access the private key. The challenge is signed using the private key and transmitted back the IDaaS service, which authenticates the user by using the public key of the passkey. In alternative embodiments, the challenge is signed by the IDaaS service using the public key, and the mobile device uses the private key to decrypt the challenge and send a response back to the IDaaS service to authenticate the user. Example user interfaces for authenticating the user using the passkey are illustrated in FIGS. 40 and 41.

If the user is authenticated (step 3004), the method 3000 continues, and the workflow defines that the user is prompted to scan a printer QR code (step 3006). If the authentication fails, the workflow defines that method 3000 ends and the physical ID card is not issued (step 3012).

The user scans the QR code using a camera of the mobile device to identify a printer at which to print physical ID card. In an example, the QR code includes a printer identification number. In an embodiment, the printer identification number includes a 16-digit hex string. In such examples, after scanning the QR code, the mobile device communicates the printer identification number to the IIDaaS service via the workflow integration platform, and the IIDaaS initiates printing of a physical ID at the printer associated with the printer identification number. As described above with the digital ID card, the IIDaaS service may define a template for the physical ID card and use information from the enrollment of the user to create a representation of the physical ID card.

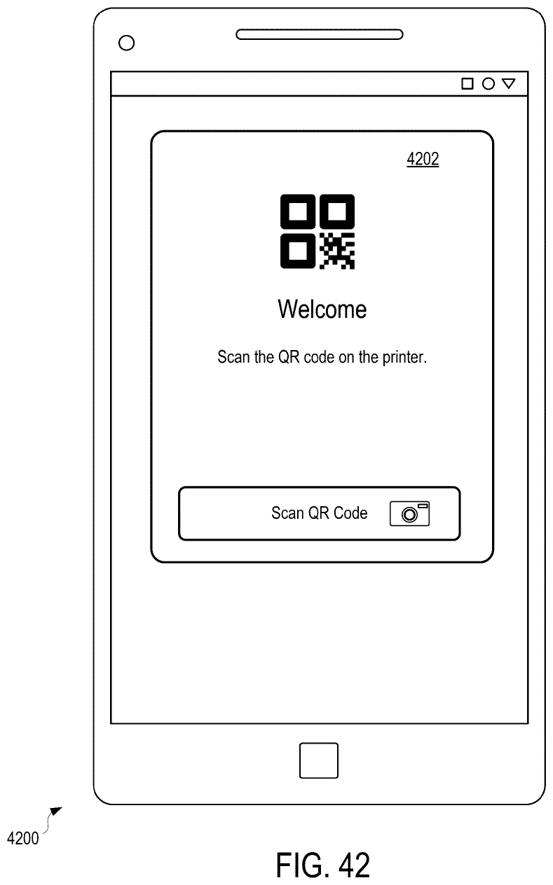

In some embodiments, the IIDaaS service transmits information about the printer (e.g., a name and a location) back to the mobile device, allowing the user to confirm that the identified printer is the printer at which the user wishes to print a physical ID card. In alternative embodiments, rather than the IIDaaS service directly initiating the printing of the physical ID card, the IIDaaS service transmits an IP address or other identifier for the printer to the workflow integration platform and/or the mobile device, allowing the mobile device to communicate with the printer (either directly or via the workflow integration platform) and initiate printing of the physical ID card from the mobile device. FIGS. 42-44 illustrate example user interfaces for scanning the QR code and initiating a printing operation for the physical ID card.

In alternative embodiments, other optical codes, such as barcodes, are used to identify the printer. Additionally, in other embodiments, other physical card issuance systems may be identified using optical codes and used to issue a physical ID card.

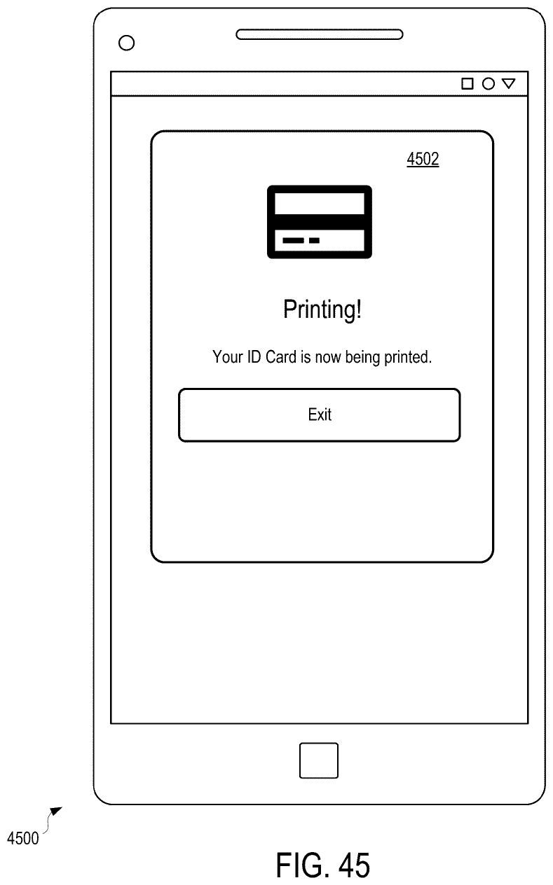

After the physical ID card is printed, the method 3000 ends (step 3010). An example user interface presented during the printing process is illustrated in FIG. 45.

FIGS. 31-45 illustrate a series of example user interfaces for registering with a card issuer and issuing digital and physical ID cards. In examples the user interfaces correspond generally to the methods 2900, 3000 described above in conjunction with FIGS. 29 and 30.

FIG. 31 is a schematic depiction of a graphical user interface 31 displayed on a mobile device to initiate registration with the card issuer and issuance of digital and physical ID cards, in accordance with an example embodiment. The graphical user interface 3100 includes an initial screen that allows a user to register and print a physical ID card. In an embodiment, the user must register before printing a physical ID card.

FIGS. 32-39 illustrate graphical user interfaces for registering with the card issuer. Graphical user interfaces substantially similar to those illustrated in FIGS. 20-24 may additionally be used in the registration process.

FIGS. 32 and 33 illustrate graphical user interfaces usable to verify a user email address. In FIG. 32, a graphical user interface 3200 presents a screen region 3202 in which a user email address is captured. As explained above, a one-time password may be sent to the captured email address and used for verification. Upon selection of a “Next” button, the graphical user interface 3300 may present a screen region 3302 in which the one-time password can be entered and verified. Upon selection of a “Next” button with that screen region 3202, the workflow integration platform may initiate identity verification by calling an IDVaaS service. Similar graphical user interfaces to those illustrated in FIGS. 20-24 may be presented during the identity verification process.

FIG. 34 illustrates an additional graphical user interface 3400 that may be presented during the identity verification process. The graphical user interface 3400 may be displayed when a similarity score between a captured self-portrait and a scanned image from an identification document is below a threshold and manual verification is required. The graphical user interface includes a screen region 3402 indicating that the application is under review.

FIG. 35 illustrate a graphical user interface 3500 presented after successful verification and registration of the user. The graphical user interface 3500 includes a screen region 3502 indicating that registration was successful.

FIGS. 36 and 37 illustrate graphical user interfaces useable to create a passkey. In FIG. 36, a graphical user interface 3600 depicts a screen region 3602 in which a user can initiate creation of a passkey. Upon selection of a “Save” button, graphical user interface 3700 may present a screen region 3702 allowing a user to create the passkey. In an embodiment, the screen region 3702 at least partially overlays the screen region 3602. Upon selection of a “Continue” button within that screen region 3702, the passkey is created. In embodiments, biometric information of the user is captured by the mobile device during creation of the passkey, and the biometric information may be required to access the passkey during subsequent authentication operations.

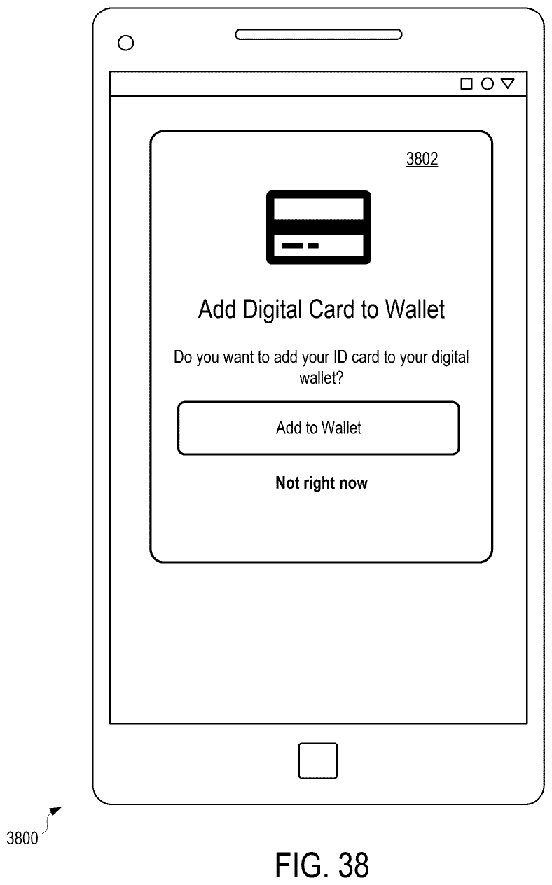

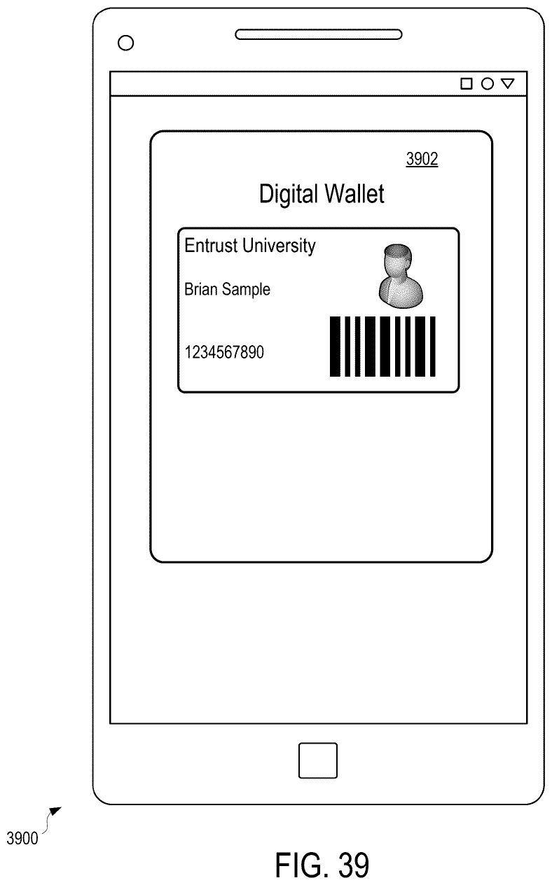

FIGS. 38 and 39 illustrate graphical user interfaces useable to issue a digital ID card. In FIG. 38, a graphical user interface 3800 depicts a screen region 3802 that includes an option for the user to add a digital ID card to a digital wallet on the mobile device. Upon selection of a “Not right now” button, no digital ID is issued. Upon selection of an “Add to Wallet” button, a digital ID card is issued to the user and stored in the user's digital wallet. FIG. 39 illustrates a graphical user interface 3900 depicting a screen region 3902 presenting a digital ID card in the user's digital wallet.

FIGS. 40-45 illustrate graphical user interfaces for issuing a physical ID card. FIGS. 40 and 41 illustrate graphical user interfaces usable to authenticate a user before issuing a physical ID card. In an embodiment, the graphical user interface 4000 shown in FIG. 40 is presented upon selection of a “Print ID Card” button on the graphical user interface 3100 shown in FIG. 31. In FIG. 40, the graphical user interface 4000 depicts a screen region 4002 that includes an option for the user to log in using the previously registered passkey. Upon selection of a “Log In” button, graphical user interface 4100 may present a screen region 4102 allowing a user to log in with a registered passkey. In an embodiment, the user must provide biometric information (e.g., a fingerprint) to access the passkey for logging in. Upon selection of a “Continue” button, the user is logged in using the passkey.

FIGS. 42-45 illustrate graphical user interfaces for printing the physical ID card. In FIG. 42, the graphical user interface 4200 presents a screen region 4202 prompting the user to scan a QR code on a printer. Upon selection of a “Scan QR Code” button, the graphical user interface 4300 presents a screen region 4302 for capturing a QR code. In an embodiment, the screen region 4302 presents visual data captured by a camera of the mobile device. Upon capture of a QR code, the graphical user interface 4400 presents a screen region 4402 listing identification information about a printer associated with the captured QR code, including a name of the printer. In alternative embodiments, additional information about the printer may be presented in the screen region 4402, including a location of the printer. Upon selection of a “Print” button, a physical ID card is printed, and graphical user interface 4500 presents a screen region 4502 confirming that the physical ID card is being printed.

Referring to FIGS. 1-45 generally, it is noted that the workflow integration platform and related flows provide significant advantages over existing platforms and systems. For example, the workflow integration platform provides a single contact point that may be used for a variety of types of services. This allows for integration with a standardized SDK, which may be incorporated into a client application easily by a financial institution or other payment entity. The SDK, in combination with the workflow integration platform manage changes to a defined workflow easily in a way that does not involve a customer institution having to change their mobile application; the change is entirely supported by the platform and SDK. As such, changes may be easily incorporated in individual defined workflows by making changes at the workflow integration platform.

Additionally, because workflows typically involve use of multiple such services, the workflow integration platform may share details across such services as needed and manage interdependencies among the services to better coordinate overall workflows, providing a simplified user experience across payment and identity services.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

### III. EXAMPLES

In accordance with the above description and following claims, a set of examples embodying aspects of this disclosure are as follows.

In Example 1, a method of facilitating an identity-based self-service workflow via an integration platform includes obtaining, from a client device, a request to initiate a workflow at a workflow integration platform including a platform database; determining a workflow type of the workflow from among a plurality of different workflow types; based on the workflow type being a workflow including two or more of a user contact information gathering service, an identity verification service, a device reputation service, an electronic signature service, or a completion service: obtaining, at the workflow integration platform, user contact information; submitting the user contact information to a workflow service to register a user and receiving a user agent identifier; providing client device information and the user agent identifier to the device reputation service; receiving from the device reputation service a device trust score; providing the device trust score to the workflow service; in response to the workflow service determining to proceed based on the user information and the device trust score, receiving a client context at the workflow integration platform; associating the workflow with a correlation identifier at the workflow integration platform; receiving, at the workflow integration platform, a result of an assessment by the identity document verification service, the result including the correlation identifier, an electronic copy of the identification document, a photo submitted to the identity document verification process from the client device, and an identity document verification score; providing a confirmation of completion of the identity document verification process to the workflow; receiving, at the workflow integration platform, a final user assessment from the workflow, the final user assessment score corresponding to a completion of the workflow.

In Example 2, the method of Example 1 is provided, further comprising, at the identity document verification service, receiving from the client device the correlation identifier, the client context, and an electronic version of a user identification document.

In Example 3, the method of Example 1 is provided, wherein the result of the assessment by the identity document verification service further includes the correlation identifier, an electronic copy of the identification document, and a photo submitted to the identity document verification process from the client device.

In Example 4, the method of Examples 1 or 2 is provided, further comprising storing the user contact information in the platform database. In some instances, the correlation identifier may be stored alongside the user contact information in the platform database.

In Example 5, the method of Example 4 is provided, further comprising storing the electronic copy of the identification document, the photo, and the result of an identity document verification process at the platform database.

In Example 6, the method of Example 5 is provided, further comprising storing a contact assessment score returned from the identity document verification service at the platform database in association with the user contact information, the electronic copy of the identification document, the photo, and the result of an identity document verification process.

In Example 7, the method of any of Examples 1-6 is provided, further comprising returning the correlation identifier to the client device prior to initiation of the identity document verification process by the client device.

In Example 8, the method of any of Examples 1-7 is provided, further comprising sending a notification to the client device of completion of the identity document verification process.

In Example 9, the method of any of Examples 1-8 is provided, wherein the client device comprises a mobile device and includes a software development kit (SDK) configured for integration into a mobile application and facilitating communication with the workflow integration platform.

In Example 10, the method of Example 9 is provided, wherein the mobile application comprises a banking application of a financial institution.

In Example 11, the method of Example 10 is provided, further comprising: receiving a change to a portion of the workflow at the integration platform, the change including a change to at least one of (1) information requested from a user of the mobile application, or (2) a threshold applied to the device trust score; and implementing the change to the portion of the workflow without changing the mobile application.

In Example 12, the method of any of Examples 1-11 is provided, further comprising: initiating an account opening process in response to completion of the workflow; and provisioning a digital wallet using information about the user gathered during the workflow.

In Example 13, the method of Example 12 is provided, further comprising issuing a digital card to the user for inclusion in the digital wallet via a process initiated at the workflow integration platform.

In Example 14, a system includes a computing system comprising a processor and a memory storing instructions which, when executed, implement a workflow integration platform providing a payment and identity application, the workflow integration platform including a platform database and being communicatively connected to a plurality of external services including at least an identity document verification service, an electronic signature service, and a device reputation service, wherein the instructions implementing the workflow integration platform cause the computing system to perform: obtaining, from a client device, a request to initiate a workflow at a workflow integration platform including a platform database; determining a workflow type of the workflow from among a plurality of different workflow types; based on the workflow type being a workflow including two or more of a user contact information gathering service, an identity verification service, a device reputation service, an electronic signature service, or a completion service: obtaining, at the workflow integration platform, user contact information; submitting the user contact information to a workflow service to register a user and receiving a user agent identifier; providing client device information and the user agent identifier to the device reputation service; receiving from the device reputation service a device trust score; providing the device trust store to the workflow service; in response to the workflow service determining to proceed based on the user information and the device trust score, receiving a client context at the workflow integration platform; associating the workflow with a correlation identifier at the workflow integration platform; receiving, at the workflow integration platform, a result of an assessment by the identity document verification service, the result including the correlation identifier, an electronic copy of the identification document, a photo submitted to the identity document verification process from the client device, and an identity document verification score; providing a confirmation of completion of the identity document verification process to the workflow; receiving, at the workflow integration platform, a final user assessment from the workflow, the final user assessment score corresponding to a completion of the workflow.

In Example 15, the system of Example 14 is provided, wherein the client device comprises a mobile device implementing a mobile application including an integration software development kit (SDK) communicatively connected to the workflow integration platform.

In Example 16, the system of Example 15 is provided, wherein the workflow integration platform includes an event broker configured to communicate with the SDK regarding a status of the workflow as tracked at the workflow integration platform.

In Example 17, the system of any of Examples 14-16 is provided, wherein the workflow comprises a financial account opening workflow.

In Example 18, the system of any of Examples 14-17 is provided, wherein the workflow further includes opening a financial account associated with the user.

In Example 19, the system of any of examples 14-18 is provided, wherein the computing system on which workflow integration platform is implemented comprises a payment and identity server, the system further comprising a bank server communicatively coupled to the payment and identity server.

In Example 20, the system of any of Examples 14-19 is provided, wherein the workflow further includes an electronic signature process utilizing an electronic signature service.

In Example 21, the system of Example 20 is provided, wherein the workflow integration platform includes a plurality of microservices, each of the microservices being configured to interface with a different one of the identity verification service, the identity document verification service, the electronic signature service, and the contact verification service.

In Example 22, a method of issuing identification cards in a self-service context via an integration platform includes obtaining, from a client device, user contact information for a user; submitting the user contact information to an identity service to verify the user contact information; receiving, from the client device, a first image of the user and an image of an identification document of the user, the identification document including a second image of the user; submitting the image of the user and the image of the identification document to an identity document verification service; receiving, from the identity document verification service, a score corresponding to a similarity between the first image of the user and the second image of the user; in response to determining that the score is above a predetermined threshold, creating an enrollment for the user in an instant identity service; and transmitting to the client device, a digital identification card, the digital identification card issued by the instant identity service.

In Example 23, the method of Example 22 is provided, further comprising: registering a passkey with the identity service, the passkey configured to authenticate the user, wherein the passkey includes: a private key stored on the client device; and a public key stored at the identity service.

In Example 24, the method of Example 23 is provided, further comprising: authenticating the user using the passkey; receiving, from the client device, a printer identification number; and transmitting the printer identification number to the instant identity service, wherein the instant identity service issues a physical identification card at a printer associated with the printer identification number.

In Example 25, the method of Example 24 is provided, wherein authenticating the user using the passkey includes: receiving, from the identity service, a challenge; transmitting the challenge to the client device; receiving, from the client device, a response to the challenge signed using the private key; and transmitting the response to the identity service, wherein the identity service verifies the response using the public key.

In Example 26, the method of Examples 24 or 25 is provided, wherein the printer identification number is captured by the client device by scanning a QR code on the printer associated with the printer identification number.

In Example 27, the method of any of Examples 24-26 is provided, wherein the printer identification number is a 16-digit hex string.

In Example 28, the method of any of Examples 24-27 is provided, wherein the physical identification card is issued based on the enrollment.

In Example 29, the method of any of Examples 24-28 is provided, further comprising: transmitting, to the client device, identification information for the printer associated with the printer identification number; and receiving, from the client device, confirmation to print the physical identification card at the printer associated with the printer identification number.

In Example 30, the method of any of Examples 23-29 is provided, wherein the private key is stored in a hardware-backed keystore on the client device.

In Example 31, the method of any of Examples 22-30 is provided, wherein the digital identification card is issued based on the enrollment.

In Example 32, the method of any of Examples 22-31 is provided, wherein verifying the user contact information includes determining that the user contact information belongs to a user associated with an institution for which the digital identification card is issued.

In Example 33, the method of any of Examples 22-32 is provided, further comprising: in response to the score being below the predetermined threshold, submitting the first image of the user and the second image of the user to an administrator for manual verification.

In Example 34, a system includes a computing system comprising a processor and a memory storing instructions which, when executed, implement a workflow integration platform providing issuance of digital and physical identification cards, the workflow integration platform including a platform database and being communicatively connected to a plurality of external services including at least an identity service, an identity document verification service, and an instant identity service; wherein the instructions implementing the workflow integration platform cause the system to: obtain, from a client device, user contact information; submit the user contact information to the identity service to verify the user contact information; receive, from the client device, a first image of the user and an image of an identification document of the user, the identification document including a second image of the user; submit the image of the user and the image of the identification document to an identity document verification service; receive, from the identity document verification service, a score corresponding to a similarity between the first image of the user and the second image of the user; in response to determining that the score is above a predetermined threshold, create an enrollment for the user in an instant identity service; and transmit to the client device, a digital identification card, the digital identification card issued by the instant identity service.

In Example 35, the system of Example 34 is provided, wherein the instructions implementing the workflow integration platform further cause the system to: register a passkey with the identity service, the passkey configured to authenticate the user, wherein the passkey includes: a private key stored on the client device; and a public key stored at the identity service.

In Example 36, the system of Example 35 is provided, wherein the instructions implementing the workflow integration platform further cause the system to: authenticate the user using the passkey; receive, from the client device, a printer identification number; and transmit the printer identification number to the instant identity service, wherein the instant identity service issues a physical identification card at a printer associated with the printer identification number.

In Example 37, the system of Example 36 is provided, wherein the instructions implementing the workflow integration platform further cause the system to: transmit, to the client device, identification information for the printer associated with the printer identification number; and receive, from the client device, confirmation to print the physical identification card at the printer associated with the printer identification number.

In Example 38, the system of Examples 36 or 37 is provided, wherein to authenticate the user using the passkey includes to: receive, from the identity service, a challenge; transmit the challenge to the client device; receive, from the client device, a response to the challenge signed using the private key; and transmit the response to the identity service, wherein the identity service verifies the response using the public key.

In Example 39, the system of any of Examples 36-38 is provided, wherein the printer identification number is captured by the client device by scanning a QR code on the printer associated with the printer identification number.

In Example 40, the system of any of Examples 34-39 is provided, wherein the instructions implementing the workflow integration platform further cause the system to: in response to the score being below the predetermined threshold, submit the first image of the user and the second image of the user to an administrator for manual verification.

In Example 40, the system of any of Example 34-40 is provided, wherein the digital identification card is issued based on the enrollment.

In Example 41, a system includes a workflow integration platform communicatively accessible via an application. The workflow integration platform being communicatively connected to a plurality of identity services including two or more of a user contact information gathering service, an identity verification service, a device reputation service, an electronic signature service, or a completion service. The system further includes an application element executable on a user device and communicatively connected to the workflow integration platform. The workflow integration platform is configurable to receive a definition of a workflow that includes a call to one or more of the plurality of identity services, the workflow being initiated in response to a request received from the application element executing on the user device. The call to the one or more of the plurality of identity services is instantiated from the workflow integration platform based on a definition of a workflow initiated in response to the request. An identity service from among the plurality of identity services completing execution communicates a service completion message and a service status to the workflow integration platform, thereby causing the workflow integration platform to call at least one other identity service of the plurality of identity services as defined in a workflow. The workflow includes, upon successful completion of the one or more identity services, communication of identity confirmation to a third party entity selected from among a financial account provider, a digital payment card issuer, or a physical card issuer.

In Example 42, the system of Example 41 is provided in which the application element comprises a software development kit (SDK) installable on a mobile device as part of the application, and wherein the application comprises a mobile application.

In Example 43, the system of any of examples 41-42 is provided, wherein the SDK is incorporated into the mobile application, and wherein the mobile application is provided by the third party entity.

In Example 44, the system of any of Examples 41-43 is provided, wherein the identity confirmation is provided to the mobile application, and wherein the mobile application communicates with the third party entity to initiate a process for which identity verification is required.

In Example 45, the system of any of Examples 41-43 is provided, wherein the workflow integration platform includes a platform database, and wherein the instructions implementing the workflow integration platform cause the system to: obtain, from the user device, user contact information; submit the user contact information to the identity verification service to verify the user contact information; receive, from the user device, a first image of the user and an image of an identification document of the user, the identification document including a second image of the user; submit the image of the user and the image of the identification document to an identity document verification service; receive, from the identity document verification service, a score corresponding to a similarity between the first image of the user and the second image of the user; in response to determining that the score is above a predetermined threshold, create an enrollment for the user in an instant identity service; and transmit to the user device, a digital identification card, the digital identification card issued by the instant identity service.

It is noted that the combinations of features recited in the above examples is intended as exemplary; other combinations are explicitly contemplated and possible, including different combinations or numbers of services included in a given workflow, and combinations of third party actions or combinations of third parties in association with a given workflow may be used.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

### APPENDIX A—FLOW DEFINITIONS (FIGS. 5-8)

title P&I Complete High-level sequence-Better, Best actor “End user” as user
participant “Bank App” as app participant “P&I SDK” as web participant “DCS SDK” as dcssdk
participant “P&I Event Broker” as broker participant “P&I System” as pni
database “P&I db” as db participant “Workflow” as workflow
participant “DCS Server” as des participant “IDVaaS SDK” as idv participant “IDVaaS API” as api
==Initialize Use Case==
user->app:I want to sign up app->web:Initialize(use case) activate web
web-#red>pni:API: Initialize(client_id, use case)
activate pni
pni->db:get tenant, workflow type
pni<-db:tenant, workflow type, workflow config pni->db:create Flow
db->pni:flow_id
pni->pni:mint JWT (flow_id) pni->pni:sign JWT
pni-#red>web:JWT, flow_id deactivate pni
web-#orange>broker:Register for SSE (flow_id) activate broker
==Start Flow==
web-#red>pni:API:[JWT] start flow (flow_id) activate pni
pni->db:get flow details and config db->pni: flow details
pni-#blue>workflow: Workflow startExecution(StateMachineArn, parameters) activate workflow #blue
workflow->workflow:init (workflow config) workflow-#blue>pni:workflowExecutionArn pni->db:update flow (workflow details)
linear
pni->broker:Send (event_id) broker-#orange>web:SSE: event_id linear off
web-#red>pni: API:[JWT] get event (event_id) pni-#red>web: event details: flow started deactivate pni
web->web: listen for more events
==User Contact Info==
workflow-#blue>pni:step:getContactInfo deactivate workflow
activate pni linear
pni->broker:Send (event_id) broker-#orange>web:SSE: event_id linear off
web-#red>pni: API:[JWT] get event (event_id)
pni-#red>web: event details: user contact details::do {form fields} deactivate pni
user<-web:render form
user->web:Enter contact information (email, phone)
web->pni:API:[JWT] add entitiy (flow_id, email, phone) activate pni
pni->pni:extract IP, user agent from HTTP request
pni->db:add entity to flow(flow_id, email, phone, ip, user_agent) pni-#red>web:entity_id
pni-#blue>workflow:step:getContactInfo done (contact info) activate workflow #blue
deactivate pni
workflow-#blue>pni:step: MC trusted device (ip, user agent) deactivate workflow
activate pni
pni->api:MC Trusted Device (IP, user agent) api->api:call MC Trusted Device API
api->pni: trusted device score
pni->db:add evaluation(trusted device score)
pni-#blue>workflow:step: MC trusted device done (trusted device score) activate workflow #blue
linear
pni->broker:Send (event_id) broker-#orange>web:SSE: event_id linear off
web-#red>pni: API:[JWT] get event (event_id) pni-#red>web:event details: user contact details::complete {entity_id} deactivate pni
note right of workflow:At this stage, we could use the device reputation \nto flag the flow as
RED and stop flow
workflow->workflow:determine next step=
==IDV==
workflow->workflow:get IDVaaS ClientContext (workflow config) workflow-#blue>pni:step:doldv(clientContext)
activate pni deactivate workflow
pni->pni:generate new correlation id
pni->db:update flow(flow id, correlation id, clientContext)
linear
pni->broker:Send (event_id) broker-#orange>web:SSE: event_id linear off
web-#red>pni: API:[JWT] get event (event_id)
pni-#red>web:event details: idv::do {correlation id, clientContext} deactivate pni
web->idv:startIdv (clientContext, correlation id) activate idv
user->idv:OCR IDdoc
user->idv:take selfie (“Best” use case only) idv->api:submit( )
idv->web:done IDV deactivate idv
web->web:listen for more events api->api:IDV Assessment
api->pni:API: payload (correlation id, IDdoc, selfie, IDV assessment) activate pni
pni->db:add entity attachements (IDdoc, selfie)
pni->db:add evaluation(IDV assessment)
pni-#blue>workflow:step:doIdv done (IDdoc.address, IDV assessment) activate workflow #blue
linear
pni->broker:Send (event_id) broker-#orange>web:SSE: event_id linear off
web-#red>pni: API:[JWT] get event (event_id) pni-#red>web:event details: idv::complete deactivate pni
==KYC==
workflow-#blue>pni:step:doKYC (contact info, address) deactivate workflow
activate pni
pni->api:doKYC(contact info, address) api->api:call MC account opening APIs api->pni:KYC assessment
pni->db:add evaluation(KYC assessment)
pni-#blue>workflow:step:doKYC done (KYC assessment) activate workflow #blue
linear
pni->broker:Send (event_id) broker-#orange>web:SSE: event_id linear off
web-#red>pni: API:[JWT] get event (event_id) pni-#red>web:event details: kyc::complete
deactivate pni
==Final Assessment==
workflow->workflow:decide green,yellow,red workflow-#blue>pni:Assessment(finalScore) deactivate workflow
activate pni
pni->db:add assessment (finalScore, risk) linear
pni->broker:Send (event_id) broker-#orange>web:SSE: event_id linear off
web-#red>pni: API:[JWT] get event (event_id) pni-#red>web:event details: assessment (risk)
deactivate pni
==risk: RED== #red
activate workflow #blue workflow->workflow:finish( ) deactivate workflow
web-#orange>broker:close connection (flow_id) deactivate broker
web->app: not eligible
deactivate web
app->user: “Sorry, apply in person”
==risk: YELLOW== #yellow activate broker
activate web
activate workflow #blue
web-#orange>broker:close connection (flow_id) deactivate broker
web->app:manual adjudication deactivate web
app->user:“Check status later”
workflow->pni:manual adjudication deactivate workflow
activate pni
pni->pni: manual adjudication
pni->db:update assessment (manually approve) pni->user:notify user (email, sms, etc)
deactivate pni
user->app:open app->web:resume( ) activate web
web-#orange>broker:reconnect for SSE (flow_id) activate broker
broker->pni:get last event activate pni
pni->broker:event_id
broker-#orange>web:SSE: event_id deactivate broker
web-#red>pni: API:[JWT] get event (event_id) pni-#red>web:event details: assessment (risk) deactivate pni
==risk: GREEN== #green web->app:passed
app->user:“verification complete”
==DCS==
workflow-#blue>pni:step:issueDigitalCard
deactivate workflow activate pni
linear
activate broker
pni->broker:Send (event_id) broker-#orange>web:SSE: event_id
deactivate broker
web-#red>pni: API:[JWT] get event (event_id)
pni-#red>web: event details: issue digital card::do {card data} deactivate pni
web->pni:API:[JWT] post enroll card (pan,expiry, client id) activate pni
activate dcs
pni->dcs: call enroll card(encrypted pan, expiry, client id)
dcs->pni: opaque enrollment data deactivate pni
pni-#red>web:enrollment data
linear off
activate dcssdk
web->dcssdk: inject enrollment data into DCS SDK dessdk->dcs: digitize and enroll the card
dcs->dessdk: result deactivate des
dessdk->web: success: WalletNotificationServiceCallback #onCardsUpdated( ) deactivate dessdk
linear activate pni
web->pni: API:[JWT] post end workflow step:issue card linear off
activate db
pni->db: create event deactivate db
pni->workflow: end step:issue digital card

### APPENDIX B-FLOW DEFINITIONS (FIGS. 9-12)

title P&I-DCS Workflow Sequence(Push Mode)-Demo
actor “End user” as user
participant “Bank App” as app participant “P&I SDK” as web participant “DCS SDK” as dcssdk
participant “DCS Server” as des participant “Bank Server” as issuer
participant “P&I Event Broker” as broker participant “P&I System” as pni
database “P&I db” as db participant “Workflow” as workflow
==risk: GREEN== #green
pni->db: create event:complete assesment(score:green) pni->workflow: end assesment step(score:green)
pni->broker: Send(event_id) broker-#orange>web: SSE: event_id
==Accept T&C==
workflow-#blue>pni: step:doAcceptT&C pni->db: create event:do accept T&C pni->broker: Send(event_id)
broker-#orange>web: SSE: event_id
web-#red>pni: API:[JWT] get event (event_id)
pni-#red>web: event details: do Accept T&C(data: may be send dynamic content as per tenant)
web->web: Shows Accept T&C Page
web->pni: API:[JWT] post end workflow step:do accept T&C pni->db: create event:complete do accept T&C
pni->workflow: end do accept T&C step pni->broker: Send(event_id)
broker-#orange>web: SSE: event_id
==Create Account==
workflow-#blue>pni: step:doCreateAccount
pni-#purple>issuer: create account: flow_id (to make call, need details in tenant configuration)
issuer-#purple>pni: API callback: create account complete(flow id, client id) pni->db: update flow instance(flow id, client id)
pni->db:create event(flow id, client id) pni->broker: Send(event_id)
broker-#orange>web: SSE: event_id pni->db:create event:complete
pni->workflow: create account workflow step:complete pni->broker: Send(event_id)
broker-#orange>web: SSE: event_id
==Provision Wallet==
workflow-#blue>pni: step:doWalletProvision pni->db: fetch client id:flow id
db->pni: result: client id
pni->db: create event:do wallet provision(client id) pni->broker: Send(event_id)
broker-#orange>web: SSE: event_id
web-#red>pni: API:[JWT] get event (event_id)
pni-#red>web: event details: do wallet provision(client id) web-#brown>dessdk:provision wallet(client id)
dcssdk-#brown>dcs: provision wallet(client id) dcs-#brown>dessdk: response: wallet id
dcssdk-#brown>web: callback: WalletManagerCallback #onConnectionSuccess( )
web->pni: API:[JWT] post end workflow step:provision wallet(not sure if we want to store wallet id)
pni->db: save(flow id, wallet id)
pni->db: create event:complete wallet provision pni->workflow: end provision wallet step
pni->broker: Send(event_id) broker-#orange>web: SSE: event_id
==Digital Card==
workflow-#blue>pni:step:issueDigitalCard
pni->db: fetch client id & wallet id:flow id db->pni: client id, wallet id
pni-#purple>issuer: Provide card details(OR Provision card): client id issuer-#purple>pni: response: client id, card id, card holder name pni-#brown>dcs: call enroll card(wallet id, card id, card holder name) dcs-#brown>pni: opaque enrollment data
pni->db: create Event(enrollment data)
linear off
pni->broker:Send (event_id) broker-#orange>web:SSE: event_id
web-#red>pni: API:[JWT] get event (event_id)
pni-#red>web: event details: issue digital card::do (enrollment data) linear
linear off
web-#brown>dcssdk: inject enrollment data: Wallet #enrollDigitalCard( ) dessdk-#brown>dcs: enroll card
dcs-#brown>dcssdk: result
dcssdk-#brown>web: success: WalletNotificationServiceCallback #onCardsUpdated( ) linear web->pni: API:[JWT] post end workflow step:issue card linear off
pni->db: create event:complete issue digital card pni->workflow: end step:issue digital card
pni->broker:Send (event_id) broker-#orange>web:SSE: event_id
web-#red>pni: API:[JWT] get event (event_id)
pni-#red>web: event details: issue digital card::complete (enrollment data)
web-#brown>dessdk: Display the card: DigitalCard #getCardDisplayService( )
==End Workflow==
workflow-#blue>pni: step:endWorkflow pni->db: create event:do end workflow pni->broker:Send (event_id)
broker-#orange>web:SSE: event_id
pni->db: create event:complete end workflow pni->workflow: end step:End Workflow
pni->broker:Send (event_id) broker-#orange>web:SSE: event_id
web-#red>pni: API:[JWT] get event (event_id)
pni-#red>web: event details: end workfow::complete web-#purple>app: callback:workflow complete

### APPENDIX C-FLOW DEFINITIONS (FIGS. 13-15)

title P&I-DCS-demo
participant “P&I Demo App” as web participant “DCS SDK” as dessdk
participant “DCS Server” as des participant “P&I Event Broker” as broker participant “P&I System” as pni
database “P&I db” as db participant “Workflow” as workflow
==risk: GREEN== #green
pni->db: create event:complete assesment(score:green) pni->workflow: end assesment step(score:green)
pni->broker: Send(event_id) broker-#orange>web: SSE: event_id
==Accept T&C==
workflow-#blue>pni: step:doAcceptT&C pni->db: create event:do accept T&C pni->broker: Send(event_id)
broker-#orange>web: SSE: event_id
web-#red>pni: API:[JWT] get event (event_id) pni-#red>web: event details: do Accept T&C
web->web: Shows Accept T&C Page
web->pni: API:[JWT] post end workflow step:do accept T&C pni->db: create event:complete do accept T&C
pni->workflow: end do accept T&C step pni->broker: Send(event_id)
broker-#orange>web: SSE: event_id
==Create Account==
workflow-#blue>pni: step:doCreate Account
pni->db:create event:do create account pni->broker: Send(event_id)
broker-#orange>web: SSE: event_id
pni->workflow: auto end create account workflow step pni->broker: Send(event_id)
broker-#orange>web: SSE: event_id
==Provision Wallet==
workflow-#blue>pni: step:doWalletProvision
pni->db: create event:do wallet provision(mock client id) pni->broker: Send(event_id)
broker-#orange>web: SSE: event_id
web-#red>pni: API:[JWT] get event (event_id)
pni-#red>web: event details: do wallet provision(client id) web-#brown>dessdk:provision wallet(client id)
dcssdk-#brown>dcs: provision wallet(client id) dcs-#brown>dessdk: response: wallet id
dcssdk-#brown>web: callback: WalletManagerCallback #onConnectionSuccess( ) web->pni: API:[JWT] post end workflow step:provision wallet(wallet id) pni->db: save(flow id, wallet id)
pni->db: create event:complete wallet provision pni->workflow: end provision wallet step
pni->broker: Send(event_id) broker-#orange>web: SSE: event_id
==Digital Card==
workflow-#blue>pni:step:issueDigitalCard pni->db: fetch wallet id:flow id
db->pni: wallet id
pni-#brown>dcs: call enroll card(wallet id, mock card id, mock card holder name) dcs-#brown>pni: opaque enrollment data
pni->db: create Event(enrollment data)
linear off
pni->broker:Send (event_id) broker-#orange>web:SSE: event_id
web-#red>pni: API:[JWT] get event (event_id)
pni-#red>web: event details: issue digital card::do (enrollment data) linear
linear off
web-#brown>dcssdk: inject enrollment data: Wallet #enrollDigitalCard( ) dcssdk-#brown>dcs: enroll card
dcs-#brown>dcssdk: result
dcssdk-#brown>web: success: WalletNotificationServiceCallback #onCardsUpdated( ) linear
web->pni: API:[JWT] post end workflow step:issue card linear off
pni->db: create event:complete issue digital card pni->workflow: end step:issue digital card
pni->broker:Send (event_id) broker-#orange>web:SSE: event_id
web-#red>pni: API:[JWT] get event (event_id)
pni-#red>web: event details: issue digital card::complete (enrollment data) web-#brown>dcssdk: Display the card: DigitalCard #getCardDisplayService( )
==End Workflow==
workflow-#blue>pni: step:endWorkflow
pni->db: create event:do end workflow pni->broker:Send (event_id)
broker-#orange>web:SSE: event_id
pni->db: create event:complete end workflow pni->workflow: end step:End Workflow
pni->broker:Send (event_id) broker-#orange>web:SSE: event_id
web-#red>pni: API:[JWT] get event (event_id)
pni-#red>web: event details: end workflow::auto complete web->web:workflow complete

1. A method of facilitating an identity-based self-service workflow via an integration platform, the method comprising:
obtaining, from a client device, a request to initiate a workflow at a workflow integration platform including a platform database;
managing the workflow, wherein the workflow includes two or more of a user contact information gathering service, an identity verification service, a device reputation service, an electronic signature service, or a completion service, and wherein managing the workflow includes:
obtaining, at the workflow integration platform, user contact information;
submitting the user contact information to a workflow service to register a user and receiving a user agent identifier;
providing client device information and the user agent identifier to the device reputation service;
receiving from the device reputation service a device trust score;
providing the device trust store to the workflow service;
in response to the workflow service determining to proceed based on the user information and the device trust score, receiving a client context at the workflow integration platform;
associating the workflow with a correlation identifier at the workflow integration platform;
receiving, at the workflow integration platform, a result of an assessment by the identity document verification service including at least an identity document verification score;
providing a confirmation of completion of the identity document verification process to the workflow; and
receiving, at the workflow integration platform, a final user assessment from the workflow, the final user assessment score corresponding to a completion of the workflow.

2. The method of claim 1, further comprising, at the identity document verification service, receiving from the client device the correlation identifier, the client context, and an electronic version of a user identification document.

3. The method of claim 1, wherein the result of the assessment by the identity document verification service further includes the correlation identifier, an electronic copy of the identification document, and a photo submitted to the identity document verification process from the client device.

4. The method of claim 1, further comprising storing the user contact information and the correlation identifier in the platform database.

5. The method of claim 4, further comprising storing the electronic copy of the identification document, the photo, and the result of an identity document verification process at the platform database.

6. The method of claim 5, further comprising storing a contact assessment score returned from the identity document verification service at the platform database in association with the user contact information, the electronic copy of the identification document, the photo, and the result of an identity document verification process.

7. The method of claim 1, further comprising returning the correlation identifier to the client device prior to initiation of the identity document verification process by the client device.

8. The method of claim 1, further comprising sending a notification to the client device of completion of the identity document verification process.

9. The method of claim 1, wherein the client device comprises a mobile device and includes a software development kit (SDK) configured for integration into a mobile application and facilitating communication with the workflow integration platform.

10. The method of claim 9, wherein the mobile application comprises a banking application of a financial institution.

11. The method of claim 10, further comprising:
receiving a change to a portion of the workflow at the integration platform, the change including a change to at least one of (1) information requested from a user of the mobile application, or (2) a threshold applied to the device trust score; and
implementing the change to the portion of the workflow without changing the mobile application.

12. The method of claim 1, further comprising:
initiating an account opening process in response to completion of the workflow; and
provisioning a digital wallet using information about the user gathered during the workflow.

13. The method of claim 12, further comprising issuing a digital card to the user for inclusion in the digital wallet via a process initiated at the workflow integration platform.

14. The method of claim 1, wherein the result of the assessment by the identity document verification service is received from the identity document verification service.

15. The method of claim 1, wherein the result of the assessment by the identity document verification service is received from the client device.

16. The method of claim 1, further comprising determining a workflow type of the workflow from among a plurality of different workflow types, and wherein the integration platform manages the workflow and selects the services base, at least in part, on the workflow type.

17. A system comprising:
a computing system comprising a processor and a memory storing instructions which, when executed, implement a workflow integration platform providing a payment and identity application, the workflow integration platform including a platform database and being communicatively connected to a plurality of external services including at least an identity document verification service, an electronic signature service, and a device reputation service,
wherein the instructions implementing the workflow integration platform cause the computing system to:
obtain, from a client device, a request to initiate a workflow at a workflow integration platform including a platform database;
managing the workflow from the workflow integration platform, the workflow including two or more of a user contact information gathering service, an identity verification service, a device reputation service, an electronic signature service, or a completion service, the workflow being executable to:
obtain, at the workflow integration platform, user contact information;
submit the user contact information to a workflow service to register a user and receive a user agent identifier;
provide client device information and the user agent identifier to the device reputation service;
receive from the device reputation service a device trust score;
provide the device trust store to the workflow service;
in response to the workflow service determining to proceed based on the user information and the device trust score, receive a client context at the workflow integration platform;
associate the workflow with a correlation identifier at the workflow integration platform;
receive, at the workflow integration platform, a result of an assessment by the identity document verification service including at least an identity document verification score;
provide a confirmation of completion of the identity document verification process to the workflow; and
receive, at the workflow integration platform, a final user assessment from the workflow, the final user assessment score corresponding to a completion of the workflow.

18. The system of claim 17, wherein the client device comprises a mobile device implementing a mobile application including an integration software development kit (SDK) communicatively connected to the workflow integration platform.

19. The system of claim 18, wherein the workflow integration platform includes an event broker configured to communicate with the SDK regarding a status of the workflow as tracked at the workflow integration platform.

20. The system of claim 17, wherein the workflow comprises a financial account opening workflow.

21. The system of claim 17, wherein the computing system on which workflow integration platform is implemented comprises a payment and identity server, the system further comprising a bank server communicatively coupled to the payment and identity server.

22. The system of claim 17, wherein the workflow further includes an electronic signature process utilizing an electronic signature service.

23. The system of claim 22, wherein the workflow integration platform includes a plurality of microservices, each of the microservices being configured to interface with a different one of the identity verification service, the identity document verification service, the electronic signature service, and the contact verification service.

24. The system of claim 17, wherein the instructions cause the computing system to determine a workflow type of the workflow from among a plurality of different workflow types, and wherein the workflow integration platform manages the workflow and selects the services base, at least in part, on the workflow type.

25. A system comprising:
a workflow integration platform communicatively accessible via an application, the workflow integration platform being communicatively connected to a plurality of services including two or more of a user contact information gathering service, an identity verification service, a device reputation service, an electronic signature service, or a completion service;
an application element executable on a user device and communicatively connected to the workflow integration platform;
wherein the workflow integration platform is configurable to receive a definition of a workflow that includes a call to one or more of the plurality of services, the workflow being initiated in response to a request received from the application element executing on the user device;
wherein the call to the one or more of the plurality of services is instantiated from the workflow integration platform based on a definition of a workflow initiated in response to the request; and
wherein an service from among the plurality of services completing execution communicates a service completion message and a service status to the workflow integration platform, thereby causing the workflow integration platform to call at least one other service of the plurality of services as defined in a workflow, and
wherein the workflow includes, upon successful completion of the one or more services, communication of identity confirmation to a third party entity selected from among a financial account provider, a digital payment card issuer, or a physical card issuer.

26. The system of claim 25, wherein the application element comprises a software development kit (SDK) installable on a mobile device as part of the application, and wherein the application comprises a mobile application.

27. The system of claim 26, wherein the SDK is incorporated into the mobile application, and wherein the mobile application is provided by the third party entity.

28. The system of claim 26, wherein the identity confirmation is provided to the mobile application, and wherein the mobile application communicates with the third party entity to initiate a process for which identity verification is required.

29. The system of claim 25, wherein the workflow integration platform includes a platform database, and wherein the instructions implementing the workflow integration platform cause the system to:
obtain, from the user device, user contact information;
submit the user contact information to the identity verification service to verify the user contact information;
receive, from the user device, a first image of the user and an image of an identification document of the user, the identification document including a second image of the user;
submit the image of the user and the image of the identification document to an identity document verification service; receive, from the identity document verification service, a score corresponding to a similarity between the first image of the user and the second image of the user;
in response to determining that the score is above a predetermined threshold, create an enrollment for the user in an instant identity service; and
transmit to the user device, a digital identification card, the digital identification card issued by the instant identity service.
